(19) United States
(12) Patent Application Publication
(10) Pub. No.: US 2005/0143051 A1
(43) Pub. Date: Jun. 30, 2005

(54) Mobile authentication/financial transaction system using a unique mobile identification code and method thereof

(75) Inventor: Kee-oh Park, Goyang (KR)

Correspondence Address: GREENBLUM & BERNSTEIN, P.L.C., 1950 ROLAND CLARKE PLACE, RESTON, VA, 20191, US

(73) Assignee: Welgate Corporation, Seoul (KR)

(21) Appl. No.: 10/863,391

(22) Filed: Jun. 9, 2004

(30) Foreign Application Priority Data
Dec. 30, 2003 (KR) 10-2003-0099987
Feb. 2, 2004 (KR) 10-2004-0006684

(51) Int. Cl. H04M 11/00

(52) U.S. Cl. 455/406

(57) ABSTRACT

The present invention discloses a mobile authentication/financial transaction system using a unique mobile identification code and method thereof, wherein mobile authentication and/or financial transaction are carried out without replacing a mobile communication terminal in such a way that various authentication and/or financial transaction are performed based on the unique mobile identification code received from a mobile communication terminal according to a standardized mobile communication protocol. A call information identification apparatus according to an aspect of the present invention includes a RF processing part for receiving a radio wave emitted from a mobile communication terminal to extract a unique mobile identification code loaded on the radio wave; a financial processing part for receiving the unique mobile identification code from the RF processing part to store the received the unique mobile identification code and a variety of financial transaction information necessary for authentication therein; and a communication processing part for receiving the unique mobile identification code or financial transaction information from the financial processing part to transmit the received unique mobile identification code or financial transaction information to an external system, and receiving information necessary for financial transaction from the external system.

The present disclosure relates to subject matter contained in priority Korean Application No.10-2003-0099987, filed on 30 Dec. 2003, and Korean Application No. 10-2004-0006684, filed on 2 Feb. 2004, which are herein expressly incorporated by reference in their entireties.

### BACKGROUND OF THE INVENTION

1. Field of the Invention

The present invention relates to a mobile authentication/financial transaction system using a unique mobile identification code and method thereof. More particularly, the present invention relates to a mobile authentication/financial transaction system using a unique mobile identification code and method thereof, wherein admission control and/or a variety of financial transactions are performed on the basis of call information transmitted by a mobile communication terminal.

2. Background of the Related Art

Recently, with communication technologies rapidly advanced, a mobile phone or a PDA (Personal Digital Assistant) (hereinafter, referred to as a “mobile communication terminal”) having a mobile communication function becomes one of indispensable personal belongings. Such a mobile communication mode can be classified mainly into a CDMA mode that has been widely used in Korea, etc. and a GSM mode that has been widely used in Europe or the US. Meanwhile, as the mobile communication terminal becomes one of indispensable personal belongings, a variety of authentication/convenience systems using the mobile communication terminal have been actively proposed.

FIG. 1 shows a network configuration of a mobile financial transaction system through a mobile communication terminal in the related art. As shown in FIG. 1, the mobile financial transaction system using the conventional mobile communication terminal may include a mobile communication terminal 2 having built a dedicated IC chip in on which credit card information is recorded, a member store 4 where a settlement processing terminal for processing credit information recorded on the IC chip is installed, a credit card company 8 for storing a customer's credit information therein and being responsible for settlement approval, and a VAN system 6 for relaying a credit settlement process between the credit card company 8 and the member store 4.

In the above construction, if a user inputs settlement information such as a settlement password and a settlement amount in a state where a settlement program is executed in the user's mobile communication terminal 2 for credit settlement after purchasing a predetermined goods at the member store 4, the user's credit information and settlement information recorded on the IC chip are sent to the settlement processing terminal of the member store 4, for example, by means of a wireless mode such as Bluetooth, IrDA or IrFM, or a near access mode such as a RF coil mode (S101). The settlement processing terminal of the member store 4 then transmits the credit information and settlement information received from the user's mobile communication terminal 2 to the VAN system 6 connected wireless thereto (S102). The VAN system 6 transfers them to the credit card company 8 to request authentication and settlement approval (S103).

Next, the credit card company 8 checks the user's credit information and settlement information received in step S103 by referring to its database and then determines whether to authenticate the user and approve the settlement. The credit card company returns the results to the VAN system 6 (S104). The VAN system 6 sends the results to the member store 4 (S105). Finally, after the settlement is approved, the member store 4 outputs a receipt (S106) and then sends it to the user. Thereby, the credit settlement process is completed. Meanwhile, the aforementioned authentication system is also actively used in a variety of admission control systems.

However, according to the mobile authentication/financial transaction system through the conventional mobile communication terminal described above, an IC chip, or wireless communication or near access related hardware on which credit information is recorded must be built in the mobile communication terminal as prerequisite conditions. Most of the mobile communication terminals commercialized in the past do not have such IC chip or hardware. Therefore, there is a problem that an authentication and/or credit transaction system is not activated.

### SUMMARY OF THE INVENTION

Accordingly, the present invention has been made in view of the above problems, and it is an object of the present invention to provide a mobile authentication/financial transaction system using a unique mobile identification code and method thereof, wherein mobile authentication and/or financial transaction are carried out without replacing a mobile communication terminal in such a way that various authentication and/or financial transaction are performed based on the unique mobile identification code received from a mobile communication terminal according to a standardized mobile communication protocol.

To achieve the above objects, according to an aspect of the present invention, there is provided a call information identification apparatus including: a RF processing part for receiving a radio wave emitted from a mobile communication terminal to extract a unique mobile identification code loaded on the radio wave; a financial processing part for receiving the unique mobile identification code from the RF processing part to store the received unique mobile identification code and a variety of financial transaction information necessary for authentication therein; and a communication processing part for receiving the unique mobile identification code or financial transaction information from the financial processing part to transmit the received unique mobile identification code or financial transaction information to an external system, and receiving information necessary for financial transaction from the external system.

According to another aspect of the present invention, there is also provided a user authentication system using a unique mobile identification code including: a mobile communication terminal for emitting a radio wave having a unique mobile identification code loaded thereon according to a predetermined condition; an authentication processing terminal having an identification code verification apparatus for receiving the radio wave emitted from the mobile communication terminal, and extracting and identifying the unique mobile identification code loaded on the radio wave; and a FEM system for storing a variety of authentication-related information containing a user's unique mobile identification code therein, comparing the unique mobile identification code received from the authentication processing terminal with the authentication-related information stored therein, and performing user authentication according to the comparison result.

According to still another aspect of the present invention, there is provided a user authentication system using a unique mobile identification code, including: a mobile communication terminal for emitting a radio wave having TMSI loaded thereon according to a predetermined condition; an authentication processing terminal having an identification code verification apparatus for receiving the radio wave emitted from the mobile communication terminal, and extracting and identifying the TMSI loaded on the radio wave; a mobile communication company system for storing the TMSI of the mobile communication terminal and IMSI information corresponding to the TMSI therein; and a FEM system for storing a variety of authentication-related information containing the IMSI of the mobile communication terminal therein, receiving the TMSI from the authentication processing terminal, comparing the TMSI and IMSI received from the mobile communication company system, and performing user authentication according to the comparison result.

According to still another aspect of the present invention, there is provided a mobile credit settlement method using a unique mobile identification code, including the steps of: (a1) allowing a PMICA POS terminal to extract a unique mobile identification code from a radio frequency signal emitted from a user's mobile communication terminal and to receive an authentication password from the user; (a2) allowing the PMICA POS terminal to transmit the unique mobile identification code, the authentication password and a settlement amount to a FEM system, thus requesting credit settlement; (a3) allowing the FEM system to perform the user authentication based on the unique mobile identification code and the authentication password and if the authentication is approved, to provide user identification information and the settlement amount to a banking system, thus requesting the credit settlement; (a4) allowing the banking system to determine whether to approve the credit settlement based on the user identification information and to transmit the approval result to the FEM system; and (a5) allowing the FEM system to notify the PMICA POS terminal of the approval result.

According to still another aspect of the present invention, there is further provided a mobile credit settlement method using a unique mobile identification code, including the steps of: (a1) allowing a PMICA POS terminal to extract TMSI from a radio frequency signal emitted from a user's mobile communication terminal and to receive an authentication password from the user; (a2) allowing the PMICA POS terminal to transmit the TMSI, the authentication password and a settlement amount to a FEM system, thus requesting credit settlement; (a3) allowing a mobile communication company system to extract TMSI from the radio frequency signal emitted from the user's mobile communication terminal, confirm IMSI corresponding to the TMSI, and transfer the IMSI to the FEM system together with the TMSI; (a4) allowing the FEM system to determine whether there exists the TMSI received in step (a3), perform user authentication based on the authentication password and the IMSI, and if the authentication is approved, provide user identification information and the settlement amount to a banking system, thus requesting credit settlement; (a5) allowing the banking system to determine whether to approve the credit settlement based on the user identification information and to transmit the approval result to the FEM system; and (a6) allowing the FEM system to notify the PMICA POS terminal of the approval result.

According to still another aspect of the present invention, there is provided a mobile credit settlement method using a unique mobile identification code, including the steps of: (a1) allowing a PMICA CD/ATM to extract a unique mobile identification code from a radio frequency signal emitted from a user's mobile communication terminal and to receive an authentication password from the user; (a2) allowing the PMICA CD/ATM to transmit the unique mobile identification code and the authentication password to a FEM system, thus requesting user authentication; (a3) allowing the FEM system to perform the user authentication based on the unique mobile identification code and the authentication password and if the authentication is approved, to transmit a settlement account no. to the PMICA CD/ATM; (a4) allowing the PMICA CD/ATM to transfer financial transaction contents requested by the user in a banking system to the banking system; (a5) allowing the banking system to determine whether to approve the financial transaction contents and notify the PMICA CD/ATM of the approval result; and (a6) allowing the PMICA CD/ATM to permit or reject the financial transaction contents according to the approval result.

According to still another aspect of the present invention, there is provided a mobile credit settlement method using a unique mobile identification code, including the steps of: (a1) allowing a PMICA CD/ATM to extract TMSI from a radio frequency signal emitted from a user's mobile communication terminal and to receive an authentication password from the user; (a2) allowing the PMICA CD/ATM to transmit the TMSI and the authentication password to a FEM system, thus requesting user authentication; (a3) allowing a mobile communication company system to extract TMSI from the radio frequency signal emitted from the user's mobile communication terminal, confirm IMSI corresponding to the TMSI, and transfer the IMSI to the FEM system together with the TMSI; (a4) allowing the FEM system to confirm whether there exists the TMSI received in step (a3), perform the user authentication based on the authentication password and the IMSI, and if the authentication is approved, transmit bank account information to the PMICA CD/ATM; (a5) allowing the PMICA CD/ATM to transfer financial transaction contents requested by the user in a banking system to the banking system; (a6) allowing the banking system to determine whether to approve the financial transaction contents and notify the PMICA CD/ATM of the approval result; and (a7) allowing the PMICA CD/ATM to permit or reject the financial transaction contents according to the approval result.

According to still another aspect of the present invention, there is provided a mobile electronic cash settlement method using a unique mobile identification code, including the steps of: (a1) allowing a PMICA POS terminal to extract a unique mobile identification code from a radio frequency signal emitted from a user's mobile communication terminal; (a2) allowing the PMICA POS terminal to transmit the unique mobile identification code and a settlement amount to a FEM system, thus requesting electronic cash settlement; and (a3) allowing the FEM system to perform the user authentication based on the unique mobile identification code, if the authentication is approved, compare remaining electronic cash of the user with the settlement amount, determine whether to approve the settlement according to the comparison result, and transmit the approval result to the PMICA POS terminal.

According to still another aspect of the present invention, there is provided a mobile electronic cash settlement method using a unique mobile identification code, including the steps of: (a1) allowing a PMICA POS terminal to extract TMSI from a radio frequency signal emitted from a user's mobile communication terminal; (a2) allowing the PMICA POS terminal to transmit the TMSI and a settlement amount to a FEM system, thus requesting electronic cash settlement; and (a3) allowing a mobile communication company system to extract TMSI from the radio frequency signal emitted from the user's mobile communication terminal, confirm IMSI corresponding to the TMSI, and transfer the IMSI to a FEM system together with the TMSI; (a4) allowing the FEM system to perform the user authentication after confirming whether there exists the TMSI received in step (a3), compare remaining electronic cash of the user with the settlement amount if the authentication is approved, determine whether to approve the settlement according to the comparison result, and transmit the approval result to the PMICA POS terminal.

According to still another aspect of the present invention, there is provided a mobile traffic fare settlement method using a unique mobile identification code, including the steps of: (a1) allowing a PMICA bus terminal to extract a unique mobile identification code from a radio frequency signal emitted from a user's mobile communication terminal, and store the unique mobile identification code in its memory together with a traffic fare; (a2) allowing a bus system to provide the unique mobile identification code and the traffic fare information, which are received from the memory of the PMICA bus terminal, to a FEM system, thus requesting settlement in a predetermined period unit; (a3) allowing the FEM system to confirm bank account information of the user being a member based on the unique mobile identification code, and provide the bank account information and the traffic fare to a banking system, thus requesting settlement; (a4) allowing the banking system to perform the settlement and provide the settlement result to the FEM system; and (a5) allowing the FEM system to transfer the settlement result to the bus system.

According to still another aspect of the present invention, there is provided a mobile traffic fare settlement method using a unique mobile identification code, including the steps of: (a1) allowing a PMICA bus terminal to extract TMSI from a radio frequency signal emitted from a user's mobile communication terminal and store the TMSI in its memory together with a traffic fare; (a2) allowing a bus system to provide the TMSI and the traffic fare information received from the memory of the PMICA bus terminal to a FEM system, thus requesting settlement in a predetermined period unit; (a3) allowing a mobile communication company system to extract TMSI from the radio frequency signal emitted from the user's mobile communication terminal, confirm IMSI corresponding to the TMSI, and transfer the IMSI to the FEM system together with the TMSI; (a4) allowing the FEM system to confirm whether there exists the TMSI received in step (a3), perform the user authentication based on the IMSI, confirm the user's bank account information if the authentication is approved, and provide the bank account information and the traffic fare to a banking system, thus requesting an accurate calculation; (a5) allowing the banking system to perform the accurate calculation and provide the accurate calculation result to the FEM system; and (a6) allowing the FEM system to transfer the accurate calculation result to the bus system.

According to still another aspect of the present invention, there is provided a mobile traffic fare settlement method using a unique mobile identification code, including the steps of: (a1) allowing a PMICA traffic terminal to extract a unique mobile identification code from a radio frequency signal emitted from a user's mobile communication terminal; (a2) allowing the PMICA traffic terminal to transmit the unique mobile identification code and a settlement amount to a FEM system, thus requesting a traffic fare settlement; (a3) allowing the FEM system to perform the user authentication based on the unique mobile identification code, and if the authentication is approved, provide the user identification information and the settlement amount to a banking system, thus requesting the traffic fare settlement; (a4) allowing the banking system to determine whether to approve the traffic fare settlement based on the user identification information and transfer the approval result to a FEM system; and (a5) allowing the FEM system to notify the PMICA traffic terminal of the approval result.

According to still another aspect of the present invention, there is provided a mobile traffic fare settlement method using a unique mobile identification code, including the steps of: (a1) allowing a PMICA traffic terminal to extract TMSI from a radio frequency signal emitted from a user's mobile communication terminal; (a2) allowing the PMICA traffic terminal to transmit the TMSI and a settlement amount to a FEM system, thus requesting a traffic fare settlement; (a3) allowing a mobile communication company system to extract TMSI from the radio frequency signal emitted from the user's mobile communication terminal, extract IMSI corresponding to the TMSI, and transfer the IMSI to the FEM system together with the TMSI; (a4) allowing the FEM system to perform the user authentication based on the IMSI after confirming whether there exists the TMSI received in step (a3), and if authentication is approved, provide user identification information and the settlement amount to a banking system; (a5) allowing the banking system to determine whether to approve the traffic fare settlement based on the user identification information, and transfer the approval result to the FEM system; and (a6) allowing the FEM system to notify the PMICA traffic terminal of the approval result.

According to still another aspect of the present invention, there is provided a mobile admission control method using a unique mobile identification code, including the steps of: (a1) allowing a PMICA door lock to extract a unique mobile identification code from a radio frequency signal emitted from a user's mobile communication terminal; (a2) allowing the PMICA door lock to transmit the unique mobile identification code to a FEM system, thus requesting authentication; (a3) allowing the FEM system to perform the user authentication based on the unique mobile identification code and then transfer user identification information corresponding to the unique mobile identification code to the PMICA door lock; and (a4) allowing the PMICA door lock to check the user identification information received in step (a3), thus determining whether to release the locking of the door.

According to still another aspect of the present invention, there is provided a mobile admission control method using a unique mobile identification code, including the steps' of: (a1) allowing a PMICA door lock to extract TMSI from a radio frequency signal emitted from a user's mobile communication terminal; (a2) allowing the PMICA door lock to transmit the TMSI to a FEM system, thus requesting authentication; (a3) allowing a mobile communication company system to extract TMSI from the radio frequency signal emitted from the user's mobile communication terminal, extract IMSI corresponding to the TMSI, and transfer the IMSI to a FEM system together with the TMSI; (a4) allowing the FEM system to perform the user authentication based on the IMSI after confirming whether there exists the TMSI received in step (a3), and transfer user identification information corresponding to the TMSI to the PMICA door lock; and (a5) allowing the PMICA door lock to check the user identification information received in step (a4), thus determining whether to release the locking of the door.

According to still another aspect of the present invention, there is provided a mobile check-up method using a unique mobile identification code, including the steps of: (a1) allowing a PMICA police terminal to extract TMSI from a radio frequency signal emitted from a user's mobile communication terminal; (a2) allowing the PMICA police terminal to transmit the TMSI to a FEM system, thus requesting authentication; (a3) allowing a mobile communication company system to extract TMSI from the radio frequency signal emitted from the user's mobile communication terminal, extract IMSI corresponding to the TMSI, and transfer the IMSI to the FEM system together with the TMSI; (a4) allowing the FEM system to perform the user authentication based on the IMSI after confirming whether there exists the TMSI received in step (a3), and if the authentication is approved, transfer corresponding user identification information to a police agency system; and (a5) allowing the police agency system to confirm the identity of the user based on the user identification information and then transfer a corresponding identity confirmation data to the PMICA police terminal.

### BRIEF DESCRIPTION OF THE DRAWINGS

Further objects and advantages of the invention can be more fully understood from the following detailed description taken in conjunction with the accompanying drawings in which:

FIG. 1 shows a network configuration of a mobile financial transaction system through a mobile communication terminal in the related art;

FIG. 2 is an internal block diagram of a call information identification apparatus of a mobile communication terminal in a mobile financial transaction system according to the present invention;

FIG. 3 is an internal block diagram of a call information identification apparatus of a mobile communication terminal in a mobile financial transaction system according to the present invention;

FIG. 4 is a network-based flowchart for describing a mobile credit settlement method for a member store subject using a unique mobile identification code according to a CDMA mode according to the present invention;

FIG. 5 is an exemplary screen showing an analysis result of call information that is generated a given mobile communication terminal through a PMICA according to the present invention;

FIG. 6 is a network-based flowchart for describing a mobile financial transaction method for a CD/ATM subject using a unique mobile identification code according to a CDMA mode according to the present invention;

FIG. 7 is a network-based flowchart for describing a method for purchasing and paying mobile electronic cash using a unique mobile identification code according to a CDMA mode according to the present invention;

FIG. 8 is a network-based flowchart for describing a traffic fare settlement method of an off-line mode using a unique mobile identification code on the basis of a CDMA mode according to the present invention;

FIG. 9 is a network-based flowchart for describing a membership subscription method through direct visit in a mobile financial transaction system using a unique mobile identification code according to a CDMA mode according to the present invention;

FIG. 10 is a network-based flowchart for describing a membership subscription method through a wired/wireless Internet in a mobile financial transaction system using a unique mobile identification code according to a CDMA mode according to the present invention;

FIG. 11 is a network-based flowchart for describing a mobile credit settlement method for a member store subject using a unique mobile identification code according to a GSM mode according to the present invention;

FIG. 12 is a network-based flowchart for describing a mobile financial transaction method for a CD/ATM using a unique mobile identification code according to a GSM mode according to the present invention;

FIG. 13 is a network-based flowchart for describing a method for purchasing and paying mobile electronic cash using a unique mobile identification code according to a GSM mode according to the present invention;

FIG. 14 is a network-based flowchart for describing a traffic fare settlement method using a unique mobile identification code according to a GSM mode according to the present invention;

FIG. 15 is a network-based flowchart for describing a membership subscription method through a direct visit in a mobile financial transaction system using a unique mobile identification code according to a GSM mode according to the present invention;

FIG. 16 is a network-based flowchart for describing a membership subscription method through a wired/wireless Internet in a mobile financial transaction system using a unique mobile identification code according to a GSM mode according to the present invention;

FIG. 17 is a network-based flowchart for describing a mobile admission control method using a unique mobile identification code according to the present invention;

FIG. 18 is a network-based flowchart for describing a mobile search method using a unique mobile identification code according to the present invention; and

FIG. 19 is a network-based flowchart for describing a traffic fare settlement method of an on-line mode using a unique mobile identification code according to the present invention.

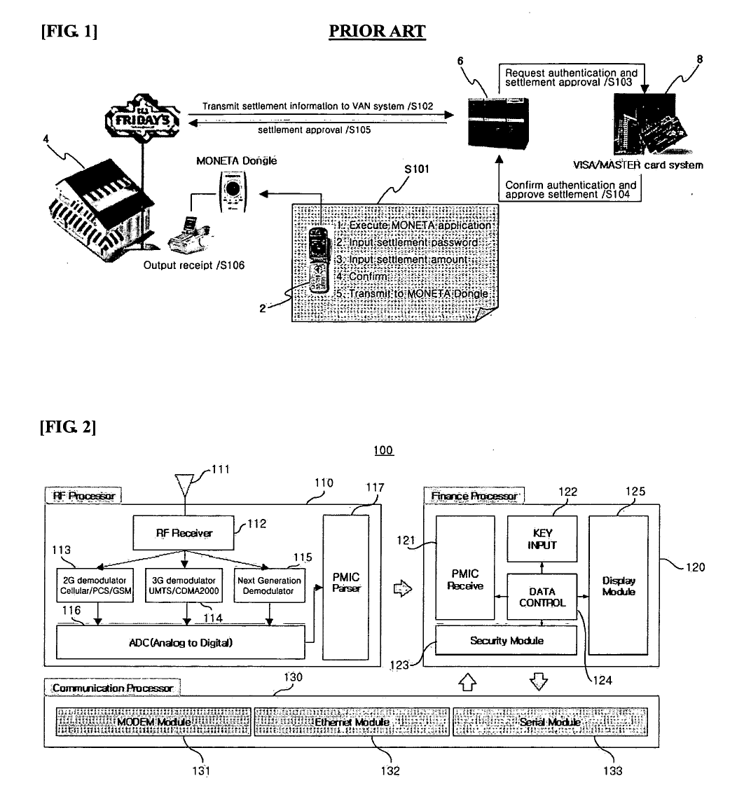

### DETAILED DESCRIPTION OF THE PREFERRED EMBODIMENT

A mobile authentication/financial transaction system using a unique mobile identification code and method thereof according to the present invention will now be described in detail by way of preferred embodiments with reference to the accompanying drawings. Technology related to the present invention in a mobile communication technology field will be first described in short.

As well known in the art, a mobile communication system of a CDMA mode that has been widely used in Korea, is mainly classified into an existing cellular phone system and a PCS (Personal Communication Service) system. The cellular phone system and the PCS system have the similar configuration except that the cellular phone system employs a radio frequency band of 800 MHz, whereas the PCS system employs a radio frequency band of 1.7 GHz-2.0 GHz, which is two or more times higher than that of the cellular phone system. Moreover, a variety of information necessary for a base station to call a mobile communication terminal, i.e., call information such as a mobile identification number (hereinafter, referred to as “MIN”) being a registered telephone number of a mobile communication terminal and an electronic serial number (hereinafter, referred to as “ESN”) being a unique manufacture number of a mobile communication terminal, is stored in the mobile communication terminal.

Meanwhile, in a situation where a user does not use the mobile communication terminal, i.e., in a standby state, the mobile communication terminal transmits a radio wave to the base station through an access channel for a short time in synchronism with a predetermined period. Such a period is called a slot cycle. In case of a mobile communication terminal used in Korea, the slot cycle is set to “slot 2” (5.12 seconds). Furthermore, the transmitted radio wave has the call information loaded thereon. The base station that received the radio wave restores the call information and sends it to a switching system, so that it can know the position of each mobile communication terminal. In addition, the radio wave on which the call information is loaded is generated even when the user manually depresses a predetermined button of the mobile communication terminal, for example, a “communication” (SEND) button.

Meanwhile, the base station in the mobile communication system of the CDMA mode can transfer an overhead message to all mobile communication terminals within the service region through the paging channel. Such overhead message contains system parameters, information about an access to a mobile communication terminal, frequency information of a base station, etc. The base station has to send the information once at least 1.28 second. The mobile communication terminal transmits its call information to the base station in response to the overhead message from the base station. In the present invention, the call information of the mobile communication terminal can be instantly acquired by a call through the paging channel.

Meanwhile, unlike the ESN and MIN of the mobile communication system of the CDMA mode, terms IMEI (International Mobile Equipment Identity) and IMSI (International Mobile Station Identity) are used in a mobile communication system of a GSM mode. Further, in the mobile communication system of the CDMA mode, the mobile communication terminal is identified using the ESN and MIN. On the contrary, in the mobile communication system of the GSM mode, the mobile communication terminal is identified using TMSI (Temporary Mobile Station Identity) temporarily generated based on the IMEI and IMSI as parameters when the mobile communication terminal is turned off or handed off. In the present invention, the ESN, MIN and TMSI are collectively called a “peculiar mobile identity code (PMIC)”.

FIG. 2 is an internal block diagram of an apparatus for identifying a unique mobile identification code of a mobile communication terminal in a mobile financial transaction system according to the present invention. This drawing shows an apparatus having only a function of receiving a unique mobile identification code from a mobile communication terminal.

As shown in FIG. 2, the apparatus for identifying the unique mobile identification code (hereinafter, referred to as simply a “PMICA” (Peculiar Mobile Identity Code Analyzer) 100 according to the present invention is mainly composed of three parts; a RF processing part 110, an authentication processing part 120 and a communication processing part 130. The RF processing part 110 includes an antenna 111 for capturing a radio signal of a mobile communication frequency band, a RF receiver 112 for dividing the radio signal received from the antenna 111 into a frequency band signal of a second-generation (G) mobile communication terminal (cellular, PCS and GSM terminal), a frequency band signal of a third-generation mobile communication terminal (UMTS and CDMA2000 terminals) and a frequency band signal of a next-generation mobile communication terminal, a second-generation demodulator 113 for demodulating a baseband signal from the frequency band signals of the second-generation, third-generation and next-generation mobile communication terminals that are divided in the RF receiver 112, a third-generation demodulator 114, a next-generation decoding unit 115, an ADC (analog to Digital Converter) 116 for converting the baseband signals of an analog form demodulated in the respective demodulators 113, 114 and 115 into corresponding digital signals, and a parser 17 for parsing the digital signals outputted from the ADC 116 to identify a unique mobile identification code. In the present invention, as all the frequency band signals of mobile communication terminals of all generations can be processed, a user can perform authentication or financial transaction by use of his or her mobile communication terminal that is currently being used in his or her country. It is also possible to selectively adopt only a mobile communication system of a mode that is currently being used in each country.

The authentication processing part 120 includes a call information receiving unit 121 for receiving call information from the parser 117 of the RF processing part 110, i.e., PMIC, a key input unit 122 for receiving a password, an start-up command, etc., which are necessary for authentication from a user or an administrator, a security module 123 for encrypting authentication-related information or financial transaction information such as a unique mobile identification code and member store identification information, a display module 125 for displaying a variety of information generated in an authentication or financial transaction processing procedure, and a data processing unit 124 for controlling the entire operation of the authentication processing part 120.

In the above construction, the key input unit 122 may usually include numerical key buttons. The display module 125 can be implemented using a diode matrix panel, a LCD panel or the like. The data control unit 124 can be implemented using a microcomputer. At this time, the data control unit 124 may include a data memory for storing various financial transaction information such as member store information, authentication-related information and a unique mobile identification code, and a program memory in which a program for controlling the entire operation of the authentication processing part 120 is stored. Further, the key input unit 122 and the display module 125 may be disposed toward a user so that the user can directly manipulate and confirm them.

The communication processing part 130 includes a modem module 131 for exchanging information included in authentication or financial transaction with an external entity through a public telephone network, an Ethernet module 132 for exchanging selling data with a central administration center in a large-scale member store, and a serial communication module 133 for exchanging information included in financial transaction with a POS installed at a member store, a CD/ATM installed at a bank, a traffic card recognition terminal and the like.

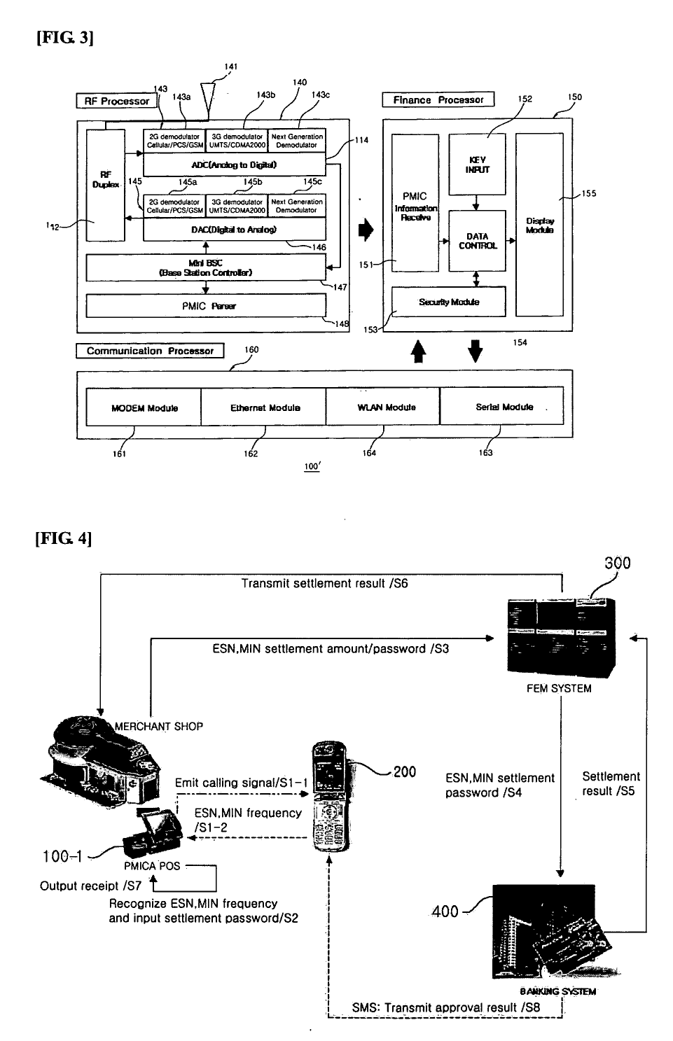

FIG. 3 is an internal block diagram of an apparatus for identifying a unique mobile identification code of a mobile communication terminal in a mobile financial transaction system according to the present invention. This drawing shows an apparatus that further includes a function of requesting a mobile communication terminal to send a unique mobile identification code.

As shown in FIG. 3, the apparatus for identifying the unique mobile identification code according to this embodiment is mainly composed of three parts; a RF processing part 140, an authentication processing part 150 and a communication processing part 160. The RF processing part 140 may include an antenna 141 for capturing a radio signal of a mobile communication frequency band and emitting a radio frequency signal (hereinafter, referred to as “calling signal”) containing an overhead message, etc., a RF duplexer 142 for dividing the radio signal received from the antenna 141 into frequency bands of respective generations, and dividing calling signals for respective generations and then transferring them to the antenna 141, a demodulator 143 (having a second-generation demodulator 143a, a third-generation demodulator 143b and a next-generation decoding unit 143c) for demodulating baseband signals from the frequency band signal of the second-generation (G) mobile communication terminal (cellular, PCS and GSM terminal), the frequency band signal of a third-generation mobile communication terminal (UMTS and CDMA2000 terminal) and the frequency band signal of a next-generation mobile communication terminal, which are divided by the RF duplexer 142, an ADC 144 for converting the baseband signals of an analog form demodulated in the demodulator 143 into digital signals, a BSC (Base Station Controller) 147 for controlling the entire operation of the RF processing part 140, a DAC 146 for converting the baseband calling signal of the analog form received from the BSC 147 into a baseband calling signal of a digital form, a modulator 145 (consisting of a second-generation modulator 145a, a third-generation modulator 145b and a fourth-generation modulator 145c) for modulating the baseband calling signal received from the DAC 146, and a parser 148 for parsing the digital signal received from the ADC 144 through the BSC 147 to identify a unique mobile identification code. In the present invention, as all the frequency band signals of mobile communication terminals of all generations can be processed, a user can perform authentication or financial transaction by use of a mobile communication terminal that is currently being used in his or her country. It is also possible to selectively adopt only a mobile communication company system of a mode that is being used in each country.

An authentication processing part 150 includes a call information receiving unit 151 for receiving call information from the parser 148 of the RF processing part 140, i.e., PMIC, a key input unit 152 for receiving a password, an start-up command, etc. which are necessary for authentication from a user or an administrator, a security module 153 for encrypting authentication-related information or financial transaction information such as a unique mobile identification code and member store identification information, a display module 155 for displaying various information generated in an authentication or financial transaction processing procedure, and a data processing unit 154 for controlling the entire operation of the authentication processing part 150.

In the above construction, the key input unit 152 may usually include numerical key buttons. The display module 155 can be implemented using a diode matrix panel, a LCD panel or the like. The data control unit 154 can be implemented using a microcomputer. At this time, the data control unit 124 may include a data memory for storing various financial transaction information such as member store information or authentication-related information and a unique mobile identification code, and a program memory in which a program for controlling the entire operation of the authentication processing part 150 is stored. Further, the key input unit 152 and the display module 155 may be disposed toward a user so that the user can directly manipulate and confirm them.

The communication processing part 160 includes a modem module 161 for exchanging information included in authentication or financial transaction with an external entity through a public telephone network, an Ethernet module 162 for exchanging selling data with a central administration center in a large-scale member store, a wireless LAN module 164, and a serial communication module 163 for exchanging information included in financial transaction with a POS installed at a member store, a CD/ATM installed at a bank, a traffic card recognition terminal or the like.

As such, the PMICA 100 and 100′ of the present invention can function independently and can be also additionally installed in a POS, a CD/ATM, a traffic card recognition terminal, which have been widely used through a simple work without modifying hardware.

FIG. 4 is a network-based flowchart for describing a mobile credit settlement method for a member store subject using a unique mobile identification code according to a CDMA mode according to the present invention. In FIG. 4, a dotted line indicates a wireless process flow and a solid line designates a wired process flow. In FIG. 4, reference numeral 100-1 may be a POS terminal (hereinafter, referred to as a “PMICA POS terminal” in the following description to be made with reference to FIG. 4) having the PMICA function shown in FIG. 2 or FIG. 3, 200 indicates a mobile communication terminal, 400 designates a banking system (a bank or a credit card company), and 300 indicates an authentication/relay entity (hereinafter, referred to as a “FEM system” (Frequency Electronic Mobile system)) disposed between the PMICA POS terminal 100-1 and the banking system 400, for performing user authentication or relay of transaction information. It is to be understood that the FEM system 300 of the present invention can be integrally operated by a mobile communication company system (not shown) or the banking system 400.

Meanwhile, the FEM system 300 has a database in which a variety of user information necessary for user authentication, i.e., a unique mobile identification code, an authentication password, member store identification information and the like of the user mobile communication terminal 200 being a member are stored. Accordingly, in order for a user or a member store to use the mobile credit settlement method of the present invention, it is required that the user or the member store become a member to the FEM system 300 in advance. This will be described in detail later on.

As shown in FIG. 4, the user's mobile communication terminal 200 emits a frequency signal on which a unique mobile identification code is loaded (S1-2). If the user being a member has his or her mobile communication terminal 200 approach to the PMICA POS terminal 100-1 for the purpose of credit settlement after selecting goods/services in a member store being a member, the PMICA POS terminal 100-1 analyzes the received frequency signal to extract a unique mobile identification code (S2). In this process, the PMICA POS terminal 100-1 may be kept in a standby state where the terminal 100-1 is always ready to receive a frequency signal, or in a standby state where the terminal 100-1 is always ready to receive the frequency signal only when a predetermined key button is depressed.

Next, the user confirms a settlement amount displayed on the display module 125 and then manipulates the key input unit 122 to input an authentication password (S2). The PMICA POS terminal 100-1 transmits the call information extracted in step (S2) and the received authentication password and settlement amount to the FEM system 300, thus requesting credit settlement (S3). The FEM system 300 that received the request performs the user authentication based on the information obtained in step S3. If the authentication is approved, the FEM system 300 sends predetermined settlement information (a unique mobile identification code, a settlement password, bank account information or other information) and the settlement amount to the banking system 400 to request credit settlement (S4).

Thereafter, the banking system 400 that received the request determines whether to approve the credit settlement according to its financial business and then transfers the result to the FEM system 300 (S5). Next, the FEM system 300 sends the settlement result received from the banking system 400 to the PMICA POS terminal 100-1. The PMICA POS terminal 100-1 outputs a receipt accordingly, thus completing the credit settlement process. Furthermore, the banking system 400 sends the approval result for the credit settlement to the user's mobile communication terminal 200 via SMS in wireless. It is thus further increase reliability of the settlement process. Although the credit settlement has been described so far, it is, however, to be noted that debit settlement (corresponding to settlement by a conventional debit card) can be performed according to the same process flow. Of course, in case of a PMICA POS terminal 100-1 adopting the apparatus of FIG. 3, step (S1-1) in which the calling signal is emitted in a predetermined period, for example, 1.28 seconds may be further included before step (S1-2), as indicated by a chain double-dashed line. It is thus possible to shorten a time taken in transaction.

Meanwhile, the radio frequency signal emitted from the mobile communication terminal has a property that it spreads into a wide space. A method for exactly recognizing a mobile communication terminal being a transaction subject from other terminals may surface as an important issue. First, frequency signals from all mobile communication terminals around the PMICA 100 and 100′ are received by increasing the receiving sensitivity of the PMICA 100 and 100′. At this time, in order to confirm a user's mobile communication terminal being a transaction subject, a method for receiving predetermined information from the user, for example, latter four digits of MIN information (the greater the number of digits, the higher the degree of exactness in confirmation) may be used. In this case, if the latter four digits of the MIN information and an authentication password are continuously received, inconvenience given to the user can be reduced.

Secondly, a method in which only frequency signals of mobile communication terminals that approach within a predetermined distance from the PMICA 100 and 100′, for example, within 30 cm, preferably to that extent that the terminals almost contact the PMICA by lowering the receiving sensitivity of the PMICA 100 and 100′, may be used. In order to further improve the exactness of confirmation, a method in which a mobile communication terminal is inserted into an electronic wave shielding space and a method in which only an antenna of a mobile communication terminal from which a frequency signal is emitted is inserted, may be used.

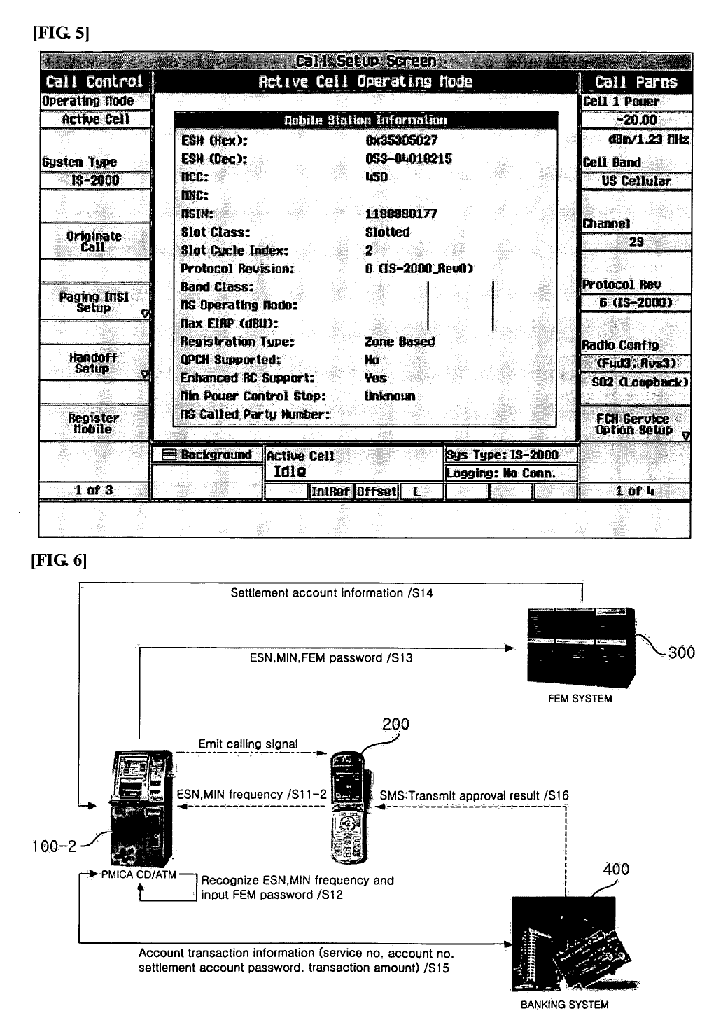

FIG. 5 is an exemplary screen showing an analysis result of call information that is generated in a given mobile communication terminal through PMICA having the method of inserting the antennal portion according to the present invention. There is shown that various useful information containing ESN and MIN are extracted through the PMICA 100 and 100′ of the present invention.

FIG. 6 is a network-based flowchart for describing a mobile financial transaction method for a CD/ATM subject using a unique mobile identification code according to a CDMA mode according to the present invention. A dotted line indicates a wireless process flow and a solid line designates a wired process flow. In FIG. 6, reference numeral 100-2 indicates a CD/ATM (hereinafter, referred to as a “PMICA CD/ATM terminal” in the following description to be made with reference to FIG. 6) having the PMICA function shown in FIG. 2 or FIG. 3, 200 indicates a mobile communication terminal, 400 designates a banking system (a bank or a credit card company), and numeral 300 indicates a FEM system disposed between the PMICA CD/ATM terminal 100-2 and the banking system 400, for performing user authentication or relay of transaction information. It is to be understood that the FEM system 300 can be integrally operated by a mobile communication company system (not shown) or the banking system 400.

Meanwhile, the FEM system 300 has a database in which a variety of user information needed for user authentication, i.e., call information, an authentication password, bank account information, etc. of the user mobile communication terminal 200 being a member are stored. Accordingly, in order to use the mobile financial transaction method of the present invention, it is required that a user become a member to the FEM system 300 in advance. This will be described in detail later on.

As shown in FIG. 6, the user's mobile communication terminal 200 emits a frequency signal with a unique mobile identification code loaded thereon (S11-2). If a user being a member makes his or her mobile communication terminal 200 approach to a PMICA POS terminal 100-2 in order to receive financial transaction services such as cash withdrawal/deposit, an account transfer or an inquiry of transaction history, the PMICA POS terminal 100-2 analyzes the received frequency signal to extract a unique mobile identification code (S12). In this process, the PMICA POS terminal 100-2 may be in a standby state where the terminal 100-1 is always ready to receive the frequency signal, or in a standby state where the terminal 100-1 is always ready to receive the frequency signal only when a predetermined key button is depressed. Next, the user inputs an authentication password (S12) by manipulating the key input unit 122 of the PMICA CD/ATM terminal 100-2.

Thereafter, the PMICA CD/ATM terminal 100-2 transfers the unique mobile identification code extracted in step S12 and the received authentication password to the FEM system 300 to request user authentication according to the financial transaction (S13). The FEM system 300 extracts user authentication and bank account information by referring to its database based on the information provided in step (S13). If authentication is approved, the FEM system 300 notifies the PMICA CD/ATM terminal 100-2 of the bank account information of the user (S14).

The above process corresponds to a process in which a CD/ATM reads a user's credit card to extract bank account information and receives a password from a user to perform the user authentication in a conventional financial transaction method by a credit card. Thereafter, the user can receive financial transaction services provided by the conventional CD/ATM. For example, in case where a cash advance service function is selected, the PMICA CD/ATM terminal 100-2 transmits account transaction information, for example, information on a unique mobile identification code, a service number, a settlement account number, an account password number, a withdrawal amount and the like to the banking system 400. The banking system 400 approves payment to the PMICA CD/ATM terminal 100-2 (S15), so that the user can withdraw cash. Meanwhile, in this process, the banking system 400 can transmit the approval result to the user's mobile communication terminal 200 via SMS (S16) in order to improve the user's convenience. In case of a PMICA CD/ATM terminal 100-2 adopting the apparatus of FIG. 3, in order to shorten a time taken in transaction, step (S11-1) in which the calling signal is emitted in a predetermined period, for example, 1.28 seconds may be added before step (S11-2), as indicated by a chain double-dashed line.

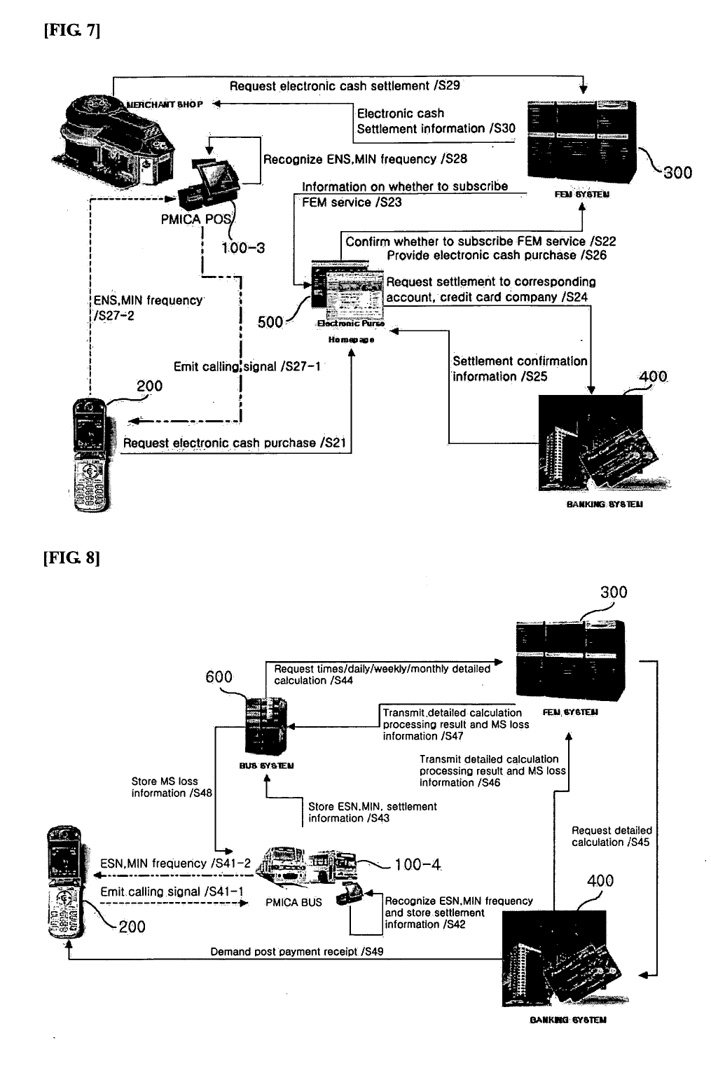

FIG. 7 is a network-based flowchart for describing a method for purchasing and paying mobile electronic cash using a unique mobile identification code according to a CDMA mode according to the present invention. In FIG. 7, a dotted line indicates a wireless process flow and a solid line designates a wired process flow. Furthermore, reference numeral 100-3 indicates a POS terminal (hereinafter, referred to as a “PMICA POS terminal” in the following description to be made with reference to FIG. 7) of a member store capable of using electronic cash, wherein the POS terminal has the PMICA function shown in FIG. 2 or FIG. 3, 200 indicates a mobile communication terminal, 400 designates a banking system (a bank or a credit card company), 500 indicates an electronic cash purchase server, and 300 indicates a FEM system disposed between the PMICA POS terminal 100-3 and the electronic cash purchase server 500, for performing user authentication or relay of transaction information. It is to be understood that the FEM system 300 can be integrally operated by a mobile communication company system (not shown) or the banking system 400.

Meanwhile, the FEM system 300 has a database in which a variety of user information necessary for user authentication, i.e., a unique mobile identification code, remaining electronic cash information, identification information of a member store and the like of the user mobile communication terminal 200 being a member are stored. Accordingly, in order to use the mobile electronic cash purchase and payment method of the present invention, it is required that a user become a member to the FEM system 300 in advance. This will be described in detail later on.

As shown in FIG. 7, in order to purchase electronic cash, the user has to access a website of the electronic cash purchase server 500 through a wireless Internet (S21). The electronic cash purchase server 500 requests confirmation on whether the user is a member, by transmitting a unique mobile identification code of the mobile communication terminal 200 extracted when the terminal 200 is connected to the wireless Internet to the FEM system 300 (S22). Thereafter, the FEM system 300 confirms whether the user is a member by referring to its database and then sends the confirmation result to the electronic cash purchase server 500 (S23). The electronic cash purchase server 500 then requests settlement to a corresponding banking system 400 according to a settlement method inputted in a purchase page when the user requests the purchase, for example, an account transfer or credit settlement (S24). The banking system 400 performs the requested settlement process and notifies the electronic cash purchase server 500 of the results (S25). The electronic cash purchase server 500 has electronic cash purchase information, i.e., amount information stored in the FEM system 300 (S26). Up to this process corresponds to a process of purchasing electronic cash.

Meanwhile, the user may access the electronic cash purchase server 500 through a wired Internet by using a client PC (not shown).

Thereafter, if the user who purchased the electronic cash has his or her mobile communication terminal 200 approach to the PMICA POS terminal 100-3 of a corresponding member store in order to use the electronic cash, the PMICA POS terminal 100-3 receives a frequency signal emitted from the mobile communication terminal 200 (S27-2) and analyzes the frequency signal to extract a unique mobile identification code (S28). In this process, the PMICA POS terminal 100-3 may be maintained in a standby state where the terminal 100-3 is always ready to receive a frequency signal, or in a standby state where the terminal 100-1 is always ready to receive the frequency signal only when a predetermined key button is depressed.

Next, the PMICA POS terminal 100-3 transmits the unique mobile identification code extracted in step (S28) and a settlement amount to the FEM system 300, thus requesting electronic cash settlement (S29). The FEM system 300 that received the request confirms user authentication and the remaining electronic cash of the user by referring to its database based on the received unique mobile identification code. If the authentication is approved and the remainder is sufficient, the FEM system 300 pays electronic cash to the PMICA POS terminal 100-3 (S30). In case of a PMICA CD/ATM terminal 100-3 adopting the apparatus of FIG. 3, in order to shorten a time taken in transaction, step (S27-1) in which the calling signal is emitted in a predetermined period, for example, 1.28 seconds may be added before step S27-2, as indicated by a chain double-dashed line.

As described above, the electronic cash purchase and payment method according to the present invention is similar to the conventional debit card settlement method and is used for small-amount settlement. Thus, the authentication procedure is omitted. If a settlement amount is high, however, a user may be requested to input an authentication password in order to further strengthen the security, like the credit settlement method described with reference to FIG. 4.

FIG. 8 is a network-based flowchart for describing a traffic fare settlement method of an off-line mode using a unique mobile identification code on the basis of a CDMA mode according to the present invention. In FIG. 8, a solid line indicates a wired process flow. Reference numeral 100-4 indicates a traffic terminal (hereinafter, referred to as a “PMICA traffic terminal” in the following description to be made with reference to FIG. 8) having, for example, the PMICA function shown in FIG. 2 or FIG. 3, 200 designates a mobile communication terminal, 400 indicates a banking system (a bank or a credit card company), 600 indicates a bus company system, and 300 designates a FEM system disposed between the banking system 400 and the bus company system 600, for performing user authentication or relay of transaction information. The FEM system 300 of the present invention can be also integrally operated by a mobile communication company system (not shown), the bus system 600 or the banking system 400.

As shown in FIG. 8, the user's mobile communication terminal 200 emits a frequency signal on which a unique mobile identification code is loaded (S41-2). In order to pay a traffic fare, if the user has his or her mobile communication terminal 200 approach to a PMICA traffic terminal 100-4, the PMICA traffic terminal 100-4 analyzes the received frequency signal to extract a unique mobile identification code and has the unique mobile identification code buffered in a its memory together with a settlement amount (S42). Subsequent processes are almost the same as those of the conventional card-type traffic fare settlement process. After running a bus, a driver detaches the PMICA traffic terminal 100-4 and then connects it to the bus company system 600 so that the unique mobile identification code and the settlement amount stored in the memory are transferred to the database of the bus company system 600 (S43).

The bus company system 600 transmits the settlement information that is collected in a predetermined period unit, for example, on a day base, a week base or a monthly base, to the FEM system 300 and then requests settlement (S44). The FEM system 300 that received the request transfers the information to the banking system 400 to request the settlement (S45). The banking system 400 sends the result of an accurate account and a unique mobile identification code of a mobile communication terminal whose loss is reported to the FEM system 300 (S46). The FEM system 300 sends the result of the accurate account and the lost information to a bus company system 600 (S47).

Thereafter, the bus company system 600 has the unique mobile identification code of the mobile communication terminal whose loss is reported to the PMICA traffic terminal 100-4 stored in the PMICA traffic terminal 100-4 (S48), so that fare settlement is not performed for the mobile communication terminal whose loss is reported. Finally, the banking system 600 charges the bus fare to the user of the mobile communication terminal 200 as a post payment (S49). In case of a PMICA traffic terminal 100-3 adopting the apparatus of FIG. 3, in order to shorten a time taken in transaction, step (S41-1) in which the calling signal is emitted in a predetermined period, for example, 1.28 seconds may be added before step S41-2, as indicated by a chain double-dashed line.

As such, according to the traffic fare settlement method of the present invention, as the settlement of a traffic fare being relatively small is processed without an authentication process, a user's convenience can be improved. Furthermore, such a traffic fare settlement method can be applied to a passage money settlement method in a subway, a railroad and a highway. For example, after the PMICA 100 and 100′ is additionally added to an existing traffic terminal installed in an entrance/exit of a subway, a railroad station, etc. or a tollgate of a highway and a bus company system is changed to a subway system or a railroad system or a tollgate system, traffic fare settlement can be performed according to the process flow shown in FIG. 8. In this case, as the PMICA traffic terminal is fixedly installed at the entrance/exit of the subway station or the railroad station or the tollgate of the highway, additional memory is not required in the PMICA traffic terminal. The FEM system 300 may serve as a gateway that performs a fare such as authentication services for the PMICA traffic terminal.

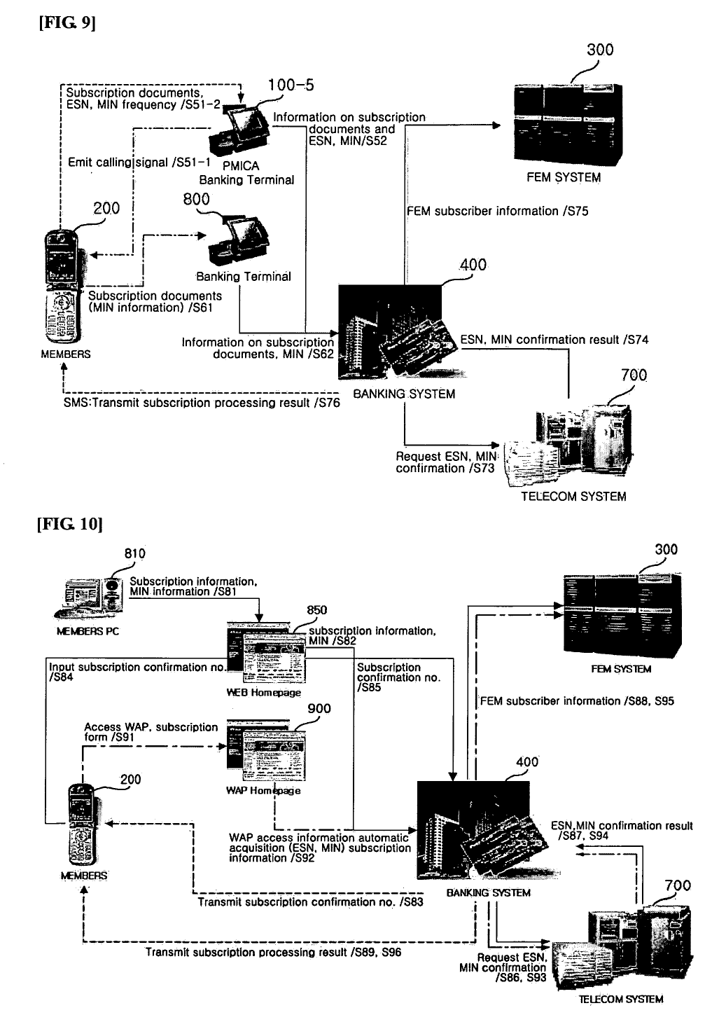

FIG. 9 is a network-based flowchart for describing a membership subscription method through direct visit in a mobile financial transaction system using a unique mobile identification code according to a CDMA mode according to the present invention. In FIG. 9, a dotted line indicates a wireless process flow, a solid line designates a wired process flow and a chain dashed line indicates a manual process flow. Further, reference numeral 100-5 indicates a banking terminal (hereinafter, referred to as a “PMICA banking terminal” in the following description to be made with reference to FIG. 9) having the PMICA function shown in FIG. 2, 200 indicates a mobile communication terminal, 800 indicates an existing banking terminal, 400 indicates a banking system (a bank or a credit card company), 700 indicates a mobile communication company system, and 300 indicates a FEM system connected to the banking system 400, for performing user authentication or relay of transaction information between the banking system 400 and other financial transaction terminals. The FEM system 300 of the present invention can be integrally operated by the mobile communication company system 700 or the banking system 400.

As shown in FIG. 9, in order to become a member of a mobile financial transaction system using a unique mobile identification code according to the present invention, a user must write a membership subscription document in which predetermined subscription information is written, submit the document to a clerk at the window and also have his or her mobile communication terminal 200 approach to the PMICA banking terminal 100-5.

However, the user's mobile communication terminal 200 emits a frequency signal on which a unique mobile identification code is loaded (S51-2). The PMICA banking terminal 100-5 analyzes the received frequency signal to extract a unique mobile identification code (S51) and then receives the subscription information written in the membership subscription document through the clerk at the window (S51). Meanwhile, if the PMICA banking terminal 100-5 is not provided but only an existing banking terminal 800 is provided, the user has to submit a membership subscription document in which subscription information containing MIN is written to the clerk at the window. Such subscription information is inputted by the clerk at the window (S61).

Next, the PMICA banking terminal 100-5 transmits the subscription information inputted through keys and the extracted unique mobile identification code to the banking system 400, thus requesting a membership subscription process (S52). In case of the existing banking terminal 800, the MIN and subscription information inputted through keys are sent to the banking system 400, thus requesting a membership subscription process (S62). Thereafter, the banking system 400 requests confirmation on whether the subscription is valid, i.e., whether the terminal is a mobile communication terminal whose loss is reported (S73) by transferring the received MIN (and ESN) to the mobile communication company system 700. The mobile communication company system 700 determines whether the subscription is valid by referring to its database and then returns the result to the banking system 400 (S74). At this time, if MIN information is received from the banking system 400, that is, if a membership subscription application is made through the existing banking terminal 800, ESN information is also transferred.

Thereafter, the banking system 400 provides the subscription information received in step (S52 or S62) and the unique mobile identification code received in step (S74) to the FEM system 300 (S75), thus completing the subscription procedure. Of course, in case of a PMICA banking terminal 100-5 adopting the apparatus of FIG. 3, in order to shorten a time taken in transaction, step (S51-1) in which the calling signal is emitted in a predetermined period, for example, 1.28 seconds is further added before step S51-2, as indicated by a chain double-dashed line.

FIG. 10 is a network-based flowchart for describing a membership subscription method through a wired/wireless Internet in a mobile financial transaction system using a unique mobile identification code according to a CDMA mode according to the present invention. In FIG. 10, a dotted line indicates a wireless process flow, a solid line indicates a wired process flow and a chained dashed line indicates a subscription process flow through WAP. Further, reference numeral 200 indicates a mobile communication terminal, 400 designates a banking system (it may be a bank or a credit card company), 700 indicates a mobile communication company system, and 300 designates a FEM system connected to the banking system 400, for performing user authentication or relay of transaction information between the banking system 300 and other financial transaction terminals. Reference numeral 810 indicates a user's client PC, 850 designates a web server for membership subscription and 900 indicates a WAP server for membership subscription. The FEM system 300 of the present invention may be integrally operated by the mobile communication company system 700 or the banking system 400.

As shown in FIG. 10, in order to become a member through the wired Internet, a user must connect the web server 850 for membership subscription using his or her client PC 810 and then input predetermined subscription information to a membership subscription page. At this time, the user has to input MIN (S81). The web server 810 for membership subscription provides the received subscription information (containing MIN) to the banking system 400, thus requesting membership subscription (S82). The banking system 400 sends a subscriber confirmation number to the mobile communication terminal 200 having MIN information via SMS so that the user can input it (S83).

Thereafter, if the user confirms the subscriber confirmation number displayed on his or her mobile communication terminal 200 and then inputs it to a subscription confirmation number page of the web server 850 for membership subscription (S84), the web server 850 for membership subscription returns the subscriber confirmation number to the banking system 400 (S85). The banking system 400 determines whether the subscriber confirmation number is identical to that sent by itself in step (S83), thus confirming whether the membership subscription applicant and the owner of the mobile communication terminal are identical.

After such confirmation is completed, the banking system 400 transfers the received MIN to the mobile communication company system 700 in order to request whether the mobile communication terminal is valid, i.e., whether the terminal is a terminal whose loss is reported (S86). The mobile communication company system 700 determines whether the terminal is valid by referring to its database and then sends the result to the banking system 400 along with ESN (S87). The banking system 400 provides the subscription information received in step (S82) and the unique mobile identification code received in step (S87) to the FEM system 300 (S88), thereby completing the subscription procedure.

The membership subscription procedure through the wireless Internet will now be described. A user must access the WAP server 900 for membership subscription through the mobile communication terminal 200 and then input predetermined subscription information to a membership subscription page (S91). The WAP server 900 for membership subscription requests membership subscription, by transferring the subscription information and a unique mobile identification code of the user's mobile communication terminal 200 that is automatically extracted when the terminal accesses the wireless Internet to the banking system 400 (S92).

Thereafter, the banking system 400 transmits the automatically extracted unique mobile identification code to the mobile communication company system 700, thus requesting whether the mobile communication terminal is valid, i.e., whether it is a terminal whose loss is reported (S93). The mobile communication company system 700 determines whether the terminal is valid by referring to its database and then sends the result to the banking system 400 along with ESN (S94). The banking system 400 provides the subscription information and the unique mobile identification code received in step (S91) to the FEM system 300 (S95), thereby completing the subscription procedure.

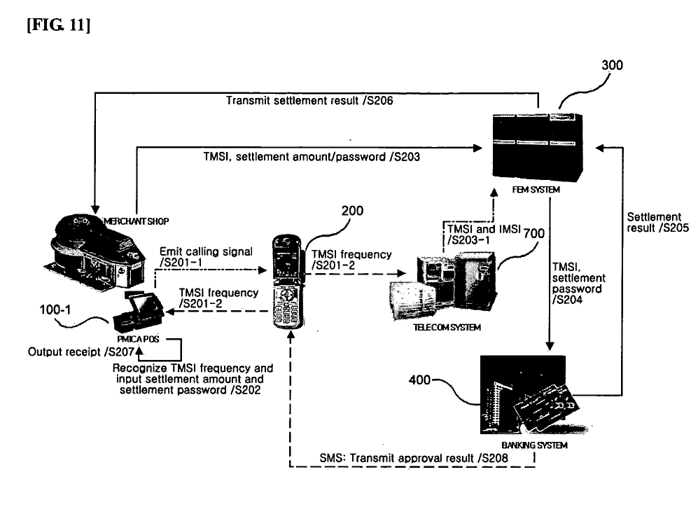

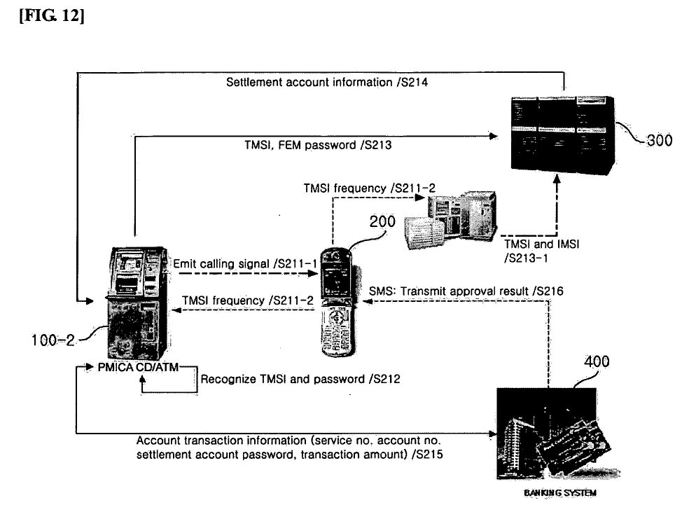

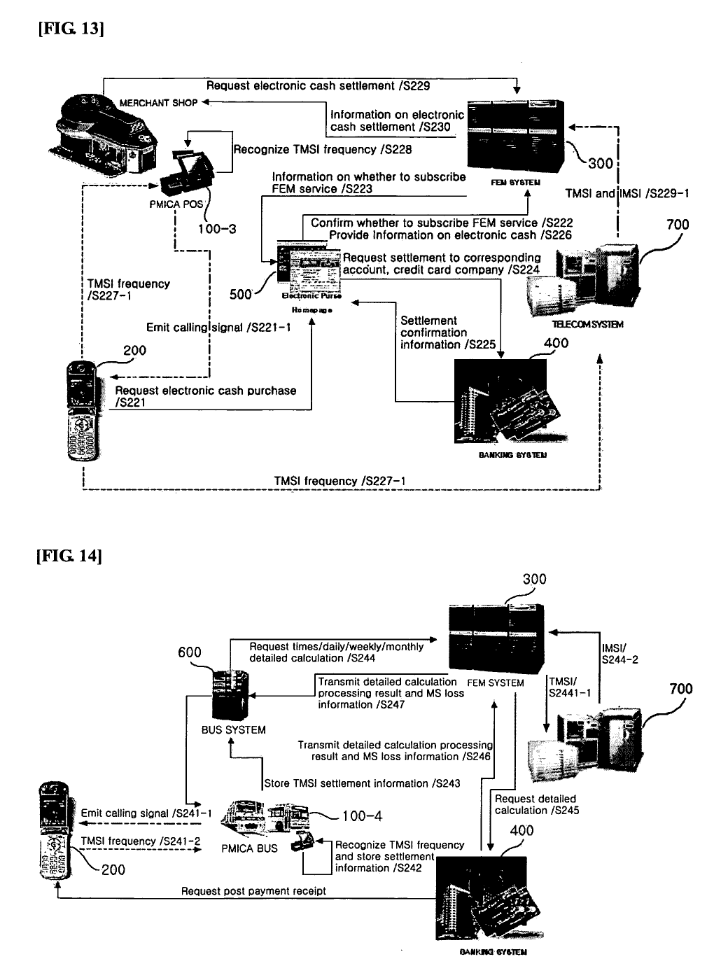

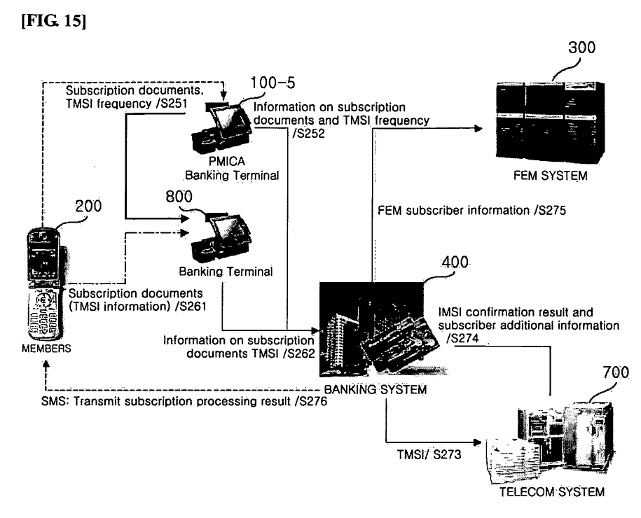

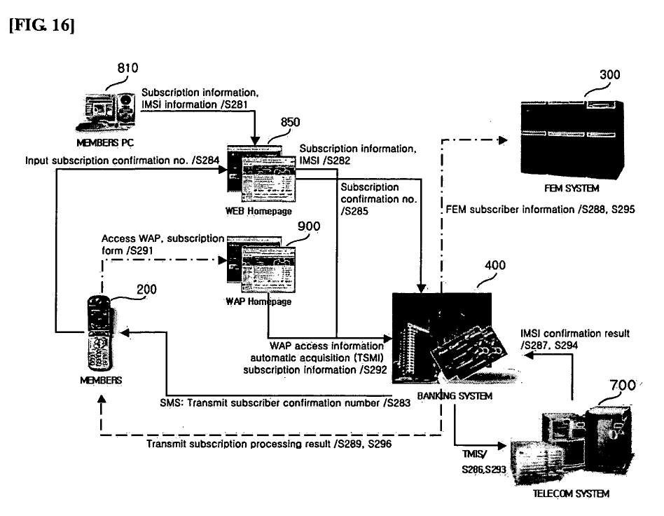

FIG. 11 is a network-based flowchart for describing a mobile credit settlement method for a member store subject using a unique mobile identification code according to a GSM mode according to the present invention, FIG. 12 is a network-based flowchart for describing a mobile financial transaction method for a CD/ATM using a unique mobile identification code according to a GSM mode according to the present invention, FIG. 13 is a network-based flowchart for describing a method for purchasing and paying mobile electronic cash using a unique mobile identification code according to a GSM mode according to the present invention, FIG. 14 is a network-based flowchart for describing a traffic fare settlement method using a unique mobile identification code according to a GSM mode according to the present invention, FIG. 15 is a network-based flowchart for describing a membership subscription method through a direct visit in a mobile financial transaction system using a unique mobile identification code according to a GSM mode according to the present invention, and FIG. 16 is a network-based flowchart for describing a membership subscription method through a wired/wireless Internet in a mobile financial transaction system using a unique mobile identification code according to a GSM mode according to the present invention.

FIG. 11 to FIG. 16 may correspond to FIG. 4, FIG. 6 to FIG. 10, respectively. In FIG. 4, FIG. 6 to FIG. 10, the ESN and MIN are used as the unique mobile identification code with the mobile communication company system not used in the authentication process. On the contrary, the process flows shown in FIG. 11 to FIG. 16 are the same as those shown in FIG. 4, FIG. 6 to FIG. 10 except that a mobile communication company system 700 is used, TMSI (and acquisition time information) is used as a unique mobile identification code, a user has to press shortcut keys that are allocated for financial transaction in advance and the SEND button (excluding a slot time method and a response method for a calling signal) in order to generate a unique mobile identification code from a mobile communication terminal 200, and the mobile communication company system 700 confirms IMSI based on TMSI emitted from the user's mobile communication terminal 200 and then resends it to the FEM system 300.

For example, in FIG. 11, the radio frequency signal emitted from the user's mobile communication terminal 200 is sent to the FEM system 300 and the mobile communication company system 700 (S201-2). The mobile communication company system 700 extracts TMSI from the radio frequency signal. The mobile communication company system 700 compares the extracted TMSI and its acquisition time information to extract a corresponding IMSI and transmits the extracted IMSI to the FEM system 300 together with the TSMI (and its reception time information) (S203-1). The FEM system 300 extracts authentication or financial transaction information corresponding to the IMSI by referring to its database, and then takes the remaining necessary steps. As the same processes to the above processes are performed in FIG. 12 to FIG. 16, detailed description on them will not be given. It is, however, to be noted that the mobile communication company system 700 may receive the TMSI (and acquisition time information) from the FEM system 300, confirm the IMSI and return the IMSI to the FEM system 300.

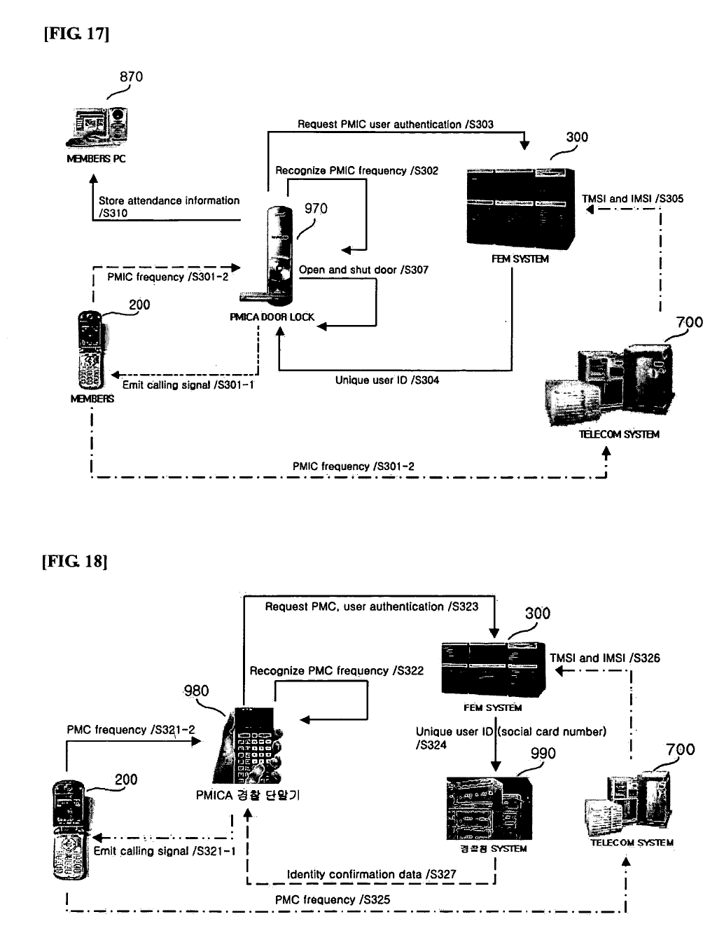

FIG. 17 is a network-based flowchart for describing a mobile admission control method using a unique mobile identification code according to the present invention. In FIG. 17, a solid line indicates a wired process flow, a chain dashed line designates a process flow specially added to the GSM mode only, and a chain double-dashed line indicates a process flow added when the PMICA shown in FIG. 3 is adopted. Furthermore, reference numeral 200 indicates a mobile communication terminal, 300 designates a FEM system for performing user authentication, 700 indicates a mobile communication company system, 870 designates a computer for management that is used for storing attendance information, and 970 indicates a door lock (hereinafter, referred to as a “PMICA door lock”) in which the PMICA 100 and 100′ shown in FIG. 2 or FIG. 3 are built. In this embodiment, the internal construction and handling data of each of the RF processing parts 110 and 140, the financial processing parts 120 and 150, and the communication processing parts 130 and 160 in the PMICA 100 and 100′ may be appropriately modified for the purpose of authentication.

Furthermore, the FEM system 300 has a database in which a variety of user information necessary for user authentication, i.e., a unique mobile identification code of a user's mobile communication terminal 200 being a member (ESN and MIN in case of the CDMA mode, and IMSI in case of the GSM mode), identification information of an entity to which the user being a member belongs (hereinafter, referred to as an “associate”, wherein the associate may be a user himself or herself being a member), and the like are stored. Accordingly, in order to use the mobile admission control method of the present invention, the user or the associate must be registered in the FEM system 300 as a member in advance.

As shown in FIG. 17, in order to enter the associate being the member, for example, if the user being the member depresses a predetermined key button with his or her mobile communication terminal 200 approaching to the PMICA door lock 970, a frequency signal on which a unique mobile identification code is loaded is emitted from the user's mobile communication terminal 200 (S301-2). This frequency signal is transmitted to the mobile communication company system 700 (S304) and is also transmitted to the PMICA door lock 970. The PMICA door lock 970 analyzes the frequency signal to extract a unique mobile identification code (S302). The PMICA door lock 970 transmits the unique mobile identification code extracted in step (S302) to the FEM system 300, thus requesting user authentication (S303). The FEM system 300 that received the request performs the user authentication based on the unique mobile identification code received in step (S303), i.e., ESN and MIN in case of the CDMA mode and then sends corresponding user identification information to the PMICA door lock 970.

Meanwhile, in case of the GSM mode, the mobile communication company system 700 extracts TMSI from the radio frequency signal received in step (S304) and then extracts a corresponding IMSI from the extracted TMSI by referring to its database based on its acquisition time information. The mobile communication company system 700 transfers the TSMI corresponding to the extracted IMSI to the FEM system 300 together with its acquisition time information (S305). The FEM system 300 determines whether the TMSI received from the mobile communication company system 700 and its acquisition time information do exist in its database. If it is determined that they exist in the database, the FEM system 300 confirms the identity of the user by referring to its database based on the IMSI and then transfers user identification information, for example, a user ID, etc. to the PMICA door lock 970 (S306).

The PMICA door lock 970 then determines whether the user identification information received thus is a registered user by referring to the computer 870 for management. Depending on the determination result, the PMICA door lock 970 may open the door or reject the opening of the door (S308). Then, the PMICA door lock 970 informs the computer 870 for management of the opening of the door or the rejection of the opening of the door (S310) for storage. Thus, the information can be used in attendance in the future. Of course, in case of the PMICA door lock 970 adopting the apparatus in FIG. 3, in order to shorten a time taken in authentication, step (S301-1) of emitting a calling signal in a predetermined period may be added before step (S301-2). The admission control system in FIG. 17 can be suitably modified so that it can be used in an unmanned store, an ATM booth, a variety of doors, automobiles or a coffer, a personal mail box, etc. Alternatively, the mobile communication company system 700 may be operated together with the FEM system 300.

FIG. 18 is a network-based flowchart for describing a mobile search method using a unique mobile identification code according to the present invention. In FIG. 18, a solid line indicates a wired process flow and a chain double-dashed line designates steps specially added in case of the GSM mode. Furthermore, reference numeral 200 indicates a mobile communication terminal, 300 designates a FEM system for performing user authentication, 700 indicates a mobile communication company system, 990 designates a police agency system, and 980 indicates a police portable terminal in which the PMICA 100 and 100′ shown in FIG. 2 or FIG. 3 are built (hereinafter, referred to as a “PMICA police terminal”). In this embodiment, the internal construction and handling data of each of the RF processing parts 110 and 140, the financial processing parts 120 and 150, and the communication processing parts 130 and 160 in the PMICA 100 and 100′ can be suitably modified for the purpose of a check-up.

In addition, the FEM system 300 has a database in which a variety of user information necessary for user authentication, i.e., a unique mobile identification code of the user mobile communication terminal 200 (ESN and MIN in case of the CDMA mode, and IMSI in case of the GSM mode), identification information and the like are stored. The PMICA police terminal 980 may be a PDA having the mobile communication function.

As shown in FIG. 18, in order to pass a check-up, if a user depresses, for example, a predetermined key button of his or her mobile communication terminal 200 around the PMICA police terminal 980, a frequency signal on which a unique mobile identification code is loaded is emitted from the user's mobile communication terminal 200 (S321-2). The frequency signal is sent to the mobile communication company system 700 (S335) and is also sent to the PMICA police terminal 980. The PMICA police terminal 980 analyzes the frequency signal to extract a unique mobile identification code (S322). The PMICA police terminal 980 transmits the unique mobile identification code extracted in step (S322) to the FEM system 300, thus requesting identity authentication for the user (S323). The FEM system 300 that received the request performs the user authentication based on the unique mobile identification code received in step (S323), i.e., ESN and MIN in case of the CDMA mode.

Meanwhile, in case of the GSM mode, the mobile communication company system 700 extracts TMSI from the radio frequency signal received in step (S325) and extracts a corresponding IMSI from the extracted TMSI by referring to its database based on its acquisition time information. The mobile communication company system 700 transfers the TSMI corresponding to the extracted IMSI to the FEM system 300 together with its acquisition time information (S326). The FEM system 300 determines whether the TMSI received from the mobile communication company system 700 and its acquisition time information do exist in its database. If it is determined that they exist in the database, the FEM system 300 confirms the identity of the user by referring to its database based on the IMSI and then transfers user identification information, for example, a user ID, etc. to the a police agency system 990 (S324). The police agency system 990 extracts identity data of the user, for example, a photograph image, etc. by referring to its database based on the user identification information received in step (S324) and then transmits the identity data to the PMICA police terminal 980 (S327), so that the police can perform a check-up while referring to the identity data.

Meanwhile, in the embodiment of FIG. 18, the FEM system 300 may be integrally operated with the police agency system 990 or the mobile communication company system 700.

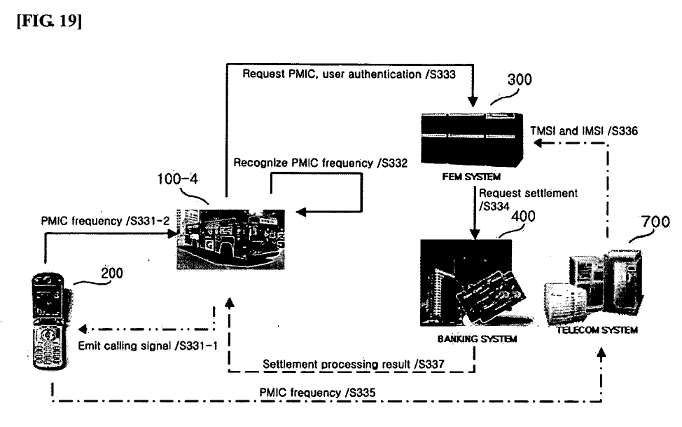

FIG. 19 is a network-based flowchart for describing a traffic fare settlement method of an on-line mode using a unique mobile identification code according to the present invention. In FIG. 19, a dotted line indicates a wireless process flow, a solid line designates a wired process flow, and a chain double-dashed line indicates steps specially added to the GSM mode only. Furthermore, reference numeral 200 indicates a mobile communication terminal, 300 designates a FEM system for performing user authentication, 700 indicates a mobile communication company system, 400 designates a banking system, and 100-4 indicates a traffic terminal in which the PMICA 100 and 100′ shown in FIG. 2 or FIG. 3 is built (hereinafter, referred to as a “PMICA traffic terminal”). In this embodiment, the internal construction and handling data of each of the RF processing parts 110 and 140, the financial processing parts 120 and 150, and the communication processing parts 130 and 160 in the PMICA 100 and 100′ may be appropriately modified for the purpose of authentication.

The FEM system 300 stores various user information necessary for authentication and settlement of a traffic fare, therein, i.e., a unique mobile identification code of the user mobile communication terminal 200 (ESN and MIN in case of the CDMA mode and IMSI in case of the GSM mode), a settlement account no. and the like.

As shown in FIG. 19, in order to pay a traffic fare, if a user depresses, for example, a predetermined key button with his or her mobile communication terminal 200 approaching to the PMICA traffic terminal 100-4, a frequency signal with a unique mobile identification code loaded thereon is emitted from the user's mobile communication terminal 200 (S321-2). The frequency signal is sent to the mobile communication company system 700 (S335) and is also sent to the PMICA traffic terminal 100-4. The PMICA traffic terminal 100-4 analyzes the frequency signal to extract a unique mobile identification code (S332). The PMICA traffic terminal 100-4 transmits the unique mobile identification code extracted in step (S332) to the FEM system 300, thus requesting identity authentication for the user (S333). The FEM system 300 that received the request performs user authentication based on the unique mobile identification code received in step (S333), i.e., ESN and MIN in case of a CDMA mode.

Meanwhile, in case of the GSM mode, the mobile communication company system 700 extracts TMSI from the radio frequency signal received in step (S335) and extracts a corresponding IMSI from the extracted TMSI by referring to its database based on its acquisition time information. The mobile communication company system 700 transfers TSMI corresponding to the extracted IMSI to the FEM system 300 together with its acquisition time information (S336). The FEM system 300 determines whether the TMSI received from the mobile communication company system 700 and its acquisition time information do exist in its database. If it is determined that they exist in the database, the FEM system 300 confirms the identity of the user by referring to its database based on the IMSI and then transfers settlement account information to the banking system 400, thus requesting the settlement (S334). The banking system 400 settles the traffic fare based on the settlement account information received in step (S334), sends the result to the PMICA traffic terminal 100-4, so that the user can know that the fare is normally processed. Of course, in case of the PMICA traffic terminal 100-4 adopting the apparatus in FIG. 3, in order to shorten a time taken in authentication, step (S331-1) of emitting the calling signal in a predetermined period may be added before step (S301-2). Meanwhile, in the embodiment of FIG. 19, the FEM system 300 may be integrally operated with the banking system 400 or the mobile communication company system 700. In addition, such a traffic fare settlement system may be used to settle the traffic fare of a subway or a railroad, a toll of a highway, etc.

The mobile authentication/financial transaction system using the unique mobile identification code and method thereof according to the present invention are not limited to the aforementioned embodiments, but may be modified in various manners without departing from the scope and spirit of the present invention. For example, the present invention can be applied to an automatic vending machine. In this case, the automatic vending machine may correspond to the PMICA POS terminal shown in FIG. 4 or FIG. 7.

Furthermore, in the aforementioned embodiments, it has been described that in case of the CDMA mode, both the ESN and MIN are included in the unique mobile identification code. It is, however, to be noted that only one of the ESN and MIN may be included in the unique mobile identification code.

The mobile authentication/financial transaction system using the unique mobile identification code and method thereof according to the present invention has the following effect.

Firstly, by adding a simple equipment to a variety of existing financial transaction terminals without replacing an existing mobile communication terminal, various mobile financial transactions such as credit settlement ad electronic cash settlement through a member store, cash deposit/withdrawal and transfer or inquiry of a transaction history through CD/ATM, traffic fare settlement through non-authentication, etc. can be performed.

Secondly, only call information such as a mobile telephone number and an equipment serial number are exposed in a financial settlement process. Accordingly, there is an effect that there is no damage even if hacking is attempted.

Thirdly, there is an effect that financial transaction is conveniently performed since user authentication is performed by way of a non-contact method.

Fourthly, there is an effect that subscription is easy and convenient since a user can become a member without directly writing call information, etc.

Fifthly, there is an effect that the present invention can be smoothly applied to various financial transactions by differentiating the degree of security.

Sixthly, in case where the present invention is applied to an admission control system, admission control can be performed without using an additional security card or a key. Accordingly, a user can enter an associate only using his or her mobile communication terminal.

Finally, in case where the present invention is applied to a check-up system, the police can examine a culprit and a wanted man without directly contacting them. It is thus possible to reduce a possible danger and to minimize traffic jam that may occur due to a blanket check-up for vehicles. Accordingly, inconvenience and social disharmony in a check-up that may be given to common people can be reduced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A call information identification apparatus, comprising:
a RF processing part for receiving a radio wave emitted from a mobile communication terminal to extract a unique mobile identification code loaded on the radio wave;
a financial processing part for receiving the unique mobile identification code from the RF processing part to store the received unique mobile identification code and a variety of financial transaction information necessary for authentication therein; and
a communication processing part for receiving the unique mobile identification code or financial transaction information from the financial processing part to transmit the received the unique mobile identification code or financial transaction information to an external system, and receiving information necessary for financial transaction from the external system.

2. The call information identification apparatus as claimed in claim 1, wherein the RF processing part comprises:
an antenna for capturing the radio wave of the mobile communication frequency band;
a RF receiver for dividing the radio wave received from the antenna into a frequency band of a second-generation mobile communication terminal, a frequency band of a third-generation mobile communication terminal and a frequency band of a next-generation mobile communication terminal;
a second-generation demodulator, a third-generation demodulator and a next-generation decoding unit each for demodulating baseband signals from the frequency bands of the second-generation, the third-generation and the next-generation mobile communication terminals, which are divided in the RF receiver;
an ADC for converting the baseband signals of an analog form demodulated in the respective demodulators into digital signals; and
a parser for parsing the digital signals received from the ADC to extract the unique mobile identification code.

3. The call information identification apparatus as claimed in claim 1, wherein the RF processing part further comprises a means for periodically emitting a calling signal.

4. The call information identification apparatus as claimed in claim 3, wherein the RF processing part comprises:
an antenna for capturing the radio wave of the mobile communication frequency band;
a RF duplexer for transferring the radio signal received from the antenna to the antenna;
a demodulator for demodulating baseband signals from the frequency band signals of the mobile communication terminals;
an ADC for converting the baseband signals of an analog form demodulated in the demodulator into digital signals;
a BSC for controlling the entire operation of the RF processing part;
an DAC for converting a baseband calling signal of an analog form received from the BSC into a baseband calling signal of a digital form;
a modulator for modulating the baseband calling signal received from the DAC; and
a parser for parsing the digital signals received from the ADC via the BSC to extract the unique mobile identification code.

5. The call information identification apparatus as claimed in claim 1, wherein the financial processing part comprises:
an identification code receiver for receiving the unique mobile identification code from the RF processing part;
a key input unit for receiving a variety of items accompanied with financial transaction;
a security module for encrypting the unique mobile identification code or financial transaction information;
a display module for displaying a variety of information occurring in a financial transaction processing procedure; and
a data processing unit for controlling the entire operation of the financial processing part.

6. The call information identification apparatus as claimed in claim 1, wherein the antenna of the RF processing part is disposed within a sealed space where the antenna of the mobile communication terminal is contained.

7. A user authentication system using a unique mobile identification code, comprising:
a mobile communication terminal for emitting a radio wave having a unique mobile identification code loaded thereon according to a predetermined condition;
an authentication processing terminal having an identification code verification apparatus for receiving the radio wave emitted from the mobile communication terminal, and extracting and identifying the unique mobile identification code loaded on the radio wave; and
a FEM system for storing a variety of authentication-related information containing a user's unique mobile identification code therein, comparing the unique mobile identification code received from the authentication processing terminal with the authentication-related information stored therein, and performing user authentication according to the comparison result.

8. The user authentication system as claimed in claim 7, wherein the predetermined condition is satisfied by a slot cycle.

9. The user authentication system as claimed in claim 7, wherein the predetermined condition is satisfied by the depression of a specific button in the mobile communication terminal.

10. The user authentication system as claimed in claim 7, wherein the identification code verification apparatus further comprises a means for periodically emitting a calling signal to the mobile communication terminal,
wherein the predetermined condition is satisfied by the reception of the periodic calling signal.

11. The user authentication system as claimed in claim 7, wherein the authentication processing terminal is a POS terminal.

12. The user authentication system as claimed in claim 7, wherein the authentication processing terminal is a CD/ATM.

13. The user authentication system as claimed in claim 7, wherein the authentication processing terminal is an automatic vending machine.

14. The user authentication system as claimed in claim 7, wherein the authentication processing terminal is a traffic terminal.

15. The user authentication system as claimed in claim 7, wherein the authentication processing terminal is a door lock.

16. The user authentication system as claimed in claim 7, wherein the authentication processing terminal is a wireless terminal for a check-up.

17. A user authentication system using a unique mobile identification code, comprising:
a mobile communication terminal for emitting a radio wave having TMSI loaded thereon according to a predetermined condition;
an authentication processing terminal having an identification code verification apparatus for receiving the radio wave emitted from the mobile communication terminal, and extracting and identifying the TMSI loaded on the radio wave; and
a mobile communication company system for storing the TMSI of the mobile communication terminal and IMSI information corresponding to the TMSI therein; and
a FEM system for storing a variety of authentication-related information containing the IMSI of the mobile communication terminal therein, receiving the TMSI from the authentication processing terminal, comparing the TMSI and IMSI received from the mobile communication company system, and performing user authentication according to the comparison result.

18. The user authentication system as claimed in claim 17, wherein the predetermined condition is satisfied by a slot cycle.

19. The user authentication system as claimed in claim 17, wherein the predetermined condition is satisfied by the depression of a specific button in the mobile communication terminal.

20. The user authentication system as claimed in claim 17, wherein the identification code verification apparatus further comprises a means for periodically emitting a calling signal to the mobile communication terminal, wherein the predetermined condition is satisfied by the reception of the periodic calling signal.

21. The user authentication system as claimed in claim 17, wherein the authentication processing terminal is a POS terminal.

22. The user authentication system as claimed in claim 17, wherein the authentication processing terminal is a CD/ATM.

23. The user authentication system as claimed in claim 17, wherein the authentication processing terminal is an automatic vending machine.

24. The user authentication system as claimed in claim 17, wherein the authentication processing terminal is a traffic terminal.

25. The user authentication system as claimed in claim 17, wherein the authentication processing terminal is a door lock.

26. The user authentication system as claimed in claim 17, wherein the authentication processing terminal is a wireless terminal for a check-up.

27. A mobile credit settlement method using a unique mobile identification code, comprising the steps of:
(a1) allowing a PMICA POS terminal to extract a unique mobile identification code from a radio frequency signal emitted from a user's mobile communication terminal and to receive an authentication password from the user;
(a2) allowing the PMICA POS terminal to transmit the unique mobile identification code, the authentication password and a settlement amount to a FEM system, thus requesting credit settlement;
(a3) allowing the FEM system to perform the user authentication based on the unique mobile identification code and the authentication password and if the authentication is approved, to provide user identification information and the settlement amount to a banking system, thus requesting the credit settlement;
(a4) allowing the banking system to determine whether to approve the credit settlement based on the user identification information and to transmit the approval result to the FEM system; and
(a5) allowing the FEM system to notify the PMICA POS terminal of the approval result.

28. A mobile credit settlement method using a unique mobile identification code, comprising the steps of:
(a1) allowing a PMICA POS terminal to extract TMSI from a radio frequency signal emitted from a user's mobile communication terminal and to receive an authentication password from the user;
(a2) allowing the PMICA POS terminal to transmit the TMSI, the authentication password and a settlement amount to a FEM system, thus requesting credit settlement;
(a3) allowing a mobile communication company system to extract TMSI from the radio frequency signal emitted from the user's mobile communication terminal, confirm IMSI corresponding to the TMSI, and transfer the IMSI to the FEM system together with the TMSI;
(a4) allowing the FEM system to determine whether there exists the TMSI received in step (a3), perform user authentication based on the authentication password and the IMSI, and if the authentication is approved, provide user identification information and the settlement amount to a banking system, thus requesting credit settlement;
(a5) allowing the banking system to determine whether to approve the credit settlement based on the user identification information and to transmit the approval result to the FEM system; and
(a6) allowing the FEM system to notify the PMICA POS terminal of the approval result.

29. A mobile credit settlement method using a unique mobile identification code, comprising the steps of:
(a1) allowing a PMICA CD/ATM to extract a unique mobile identification code from a radio frequency signal emitted from a user's mobile communication terminal and to receive an authentication password from the user;
(a2) allowing the PMICA CD/ATM to transmit the unique mobile identification code and the authentication password to a FEM system, thus requesting user authentication;
(a3) allowing the FEM system to perform the user authentication based on the unique mobile identification code and the authentication password and if the authentication is approved, to transmit a settlement account no. to the PMICA CD/ATM;
(a4) allowing the PMICA CD/ATM to transfer financial transaction contents requested by the user in a banking system to the banking system;
(a5) allowing the banking system to determine whether to approve the financial transaction contents and notify the PMICA CD/ATM of the approval result; and
(a6) allowing the PMICA CD/ATM to permit or reject the financial transaction contents according to the approval result.

30. A mobile credit settlement method using a unique mobile identification code, comprising the steps of:
(a1) allowing a PMICA CD/ATM to extract TMSI from a radio frequency signal emitted from a user's mobile communication terminal and to receive an authentication password from the user;
(a2) allowing the PMICA CD/ATM to transmit the TMSI and the authentication password to a FEM system, thus requesting user authentication;
(a3) allowing a mobile communication company system to extract TMSI from the radio frequency signal emitted from the user's mobile communication terminal, confirm IMSI corresponding to the TMSI, and transfer the IMSI to the FEM system together with the TMSI;
(a4) allowing the FEM system to confirm whether there exists the TMSI received in step (a3), perform the user authentication based on the authentication password and the IMSI, and if the authentication is approved, transmit bank account information to the PMICA CD/ATM;
(a5) allowing the PMICA CD/ATM to transfer financial transaction contents requested by the user in a banking system to the banking system;
(a6) allowing the banking system to determine whether to approve the financial transaction contents and notify the PMICA CD/ATM of the approval result; and
(a7) allowing the PMICA CD/ATM to permit or reject the financial transaction contents according to the approval result.

31. A mobile electronic cash settlement method using a unique mobile identification code, comprising the steps of:
(a1) allowing a PMICA POS terminal to extract a unique mobile identification code from a radio frequency signal emitted from a user's mobile communication terminal;
(a2) allowing the PMICA POS terminal to transmit the unique mobile identification code and a settlement amount to a FEM system, thus requesting electronic cash settlement; and
(a3) allowing the FEM system to perform the user authentication based on the unique mobile identification code, if the authentication is approved, compare remaining electronic cash of the user with the settlement amount, determine whether to approve the settlement according to the comparison result, and transmit the approval result to the PMICA POS terminal.

32. The mobile electronic cash settlement method as claimed in claim 31, wherein the purchase of the electronic cash is performed by the steps of:
(a4) allowing the user to access an electronic cash purchase server, provide predetermined membership information and then request the purchase of the electronic cash;
(a5) allowing the electronic cash purchase server to provide the membership information to the FEM system, thus requesting confirmation on whether the user is a member;
(a6) allowing the FEM system to determine whether the user is a member by referring to its database, and then notify the electronic cash purchase server of the determination result together with settlement information of the member;
(a7) allowing the electronic cash purchase server to transmit the settlement information and a purchase request amount to a banking system, thus requesting settlement;
(a8) allowing the banking system to determine whether to approve the settlement and notify the electronic cash purchase server of the approval result;
(a9) allowing the electronic cash purchase server to notify the FEM system of the purchased electronic cash information; and
(a10) allowing the FEM system to store the purchased electronic cash information therein.

33. The mobile electronic cash settlement method as claimed in claim 32, wherein the electronic cash purchase server is a WAP server, and the predetermined membership information in step (a5) is a unique mobile identification code that is automatically extracted by the user's mobile communication terminal, which is used for access.

34. A mobile electronic cash settlement method using a unique mobile identification code, comprising the steps of:
(a1) allowing a PMICA POS terminal to extract TMSI from a radio frequency signal emitted from a user's mobile communication terminal;
(a2) allowing the PMICA POS terminal to transmit the TMSI and a settlement amount to a FEM system, thus requesting electronic cash settlement; and
(a3) allowing a mobile communication company system to extract TMSI from the radio frequency signal emitted from the user's mobile communication terminal, confirm IMSI corresponding to the TMSI, and transfer the IMSI to a FEM system together with the TMSI;
(a4) allowing the FEM system to perform the user authentication after confirming whether there exists the TMSI received in step (a3), compare remaining electronic cash of the user with the settlement amount if the authentication is approved, determine whether to approve the settlement according to the comparison result, and transmit the approval result to the PMICA POS terminal.

35. The mobile electronic cash settlement method as claimed in claim 34, wherein the purchase of the electronic cash is performed the by steps of:
(a5) allowing the user to access an electronic cash purchase server, provide predetermined membership information and then request the purchase of the electronic cash;
(a6) allowing the electronic cash purchase server to provide the membership information to the FEM system, thus requesting confirmation on whether the user is a member;
(a7) allowing the FEM system to determine whether the user is a member by referring to its database, and then notify the electronic cash purchase server of the determination result together with settlement information of the member;
(a8) allowing the electronic cash purchase server to transmit the settlement information and a purchase request amount to a banking system, thus requesting settlement;
(a9) allowing the banking system to determine whether to approve the settlement and notify the electronic cash purchase server of the approval result;
(a10) allowing the electronic cash purchase server to notify the FEM system of the purchased electronic cash information; and
(a11) allowing the FEM system to store the purchased electronic cash information therein.

36. A mobile traffic fare settlement method using a unique mobile identification code, comprising the steps of:
(a1) allowing a PMICA bus terminal to extract a unique mobile identification code from a radio frequency signal emitted from a user's mobile communication terminal, and store the unique mobile identification code in its memory together with a traffic fare;
(a2) allowing a bus system to provide the unique mobile identification code and the traffic fare information, which are received from the memory of the PMICA bus terminal, to a FEM system, thus requesting settlement in a predetermined period unit;
(a3) allowing the FEM system to confirm bank account information of the user being a member based on the unique mobile identification code, and provide the bank account information and the traffic fare to a banking system, thus requesting settlement;
(a4) allowing the banking system to perform the settlement and provide the settlement result to the FEM system; and
(a5) allowing the FEM system to transfer the settlement result to the bus system.

37. The mobile traffic fare settlement method as claimed in claim 36, wherein in step (a4), the banking system provides a unique mobile identification code of a mobile communication terminal whose loss is reported to the FEM system,
in step (a5), the FEM system provides the unique mobile identification code of the mobile communication terminal whose loss is reported to the bus system, and
the bus system has the unique mobile identification code of the mobile communication terminal whose loss is reported stored in the PMICA bus terminal, so that a traffic fare settlement for the mobile communication terminal whose loss is reported is rejected.

38. A mobile traffic fare settlement method using a unique mobile identification code, comprising the steps of:
(a1) allowing a PMICA bus terminal to extract TMSI from a radio frequency signal emitted from a user's mobile communication terminal and store the TMSI in its memory together with a traffic fare;
(a2) allowing a bus system to provide the TMSI and the traffic fare information received from the memory of the PMICA bus terminal to a FEM system, thus requesting settlement in a predetermined period unit;
(a3) allowing a mobile communication company system to extract TMSI from the radio frequency signal emitted from the user's mobile communication terminal, confirm IMSI corresponding to the TMSI, and transfer the IMSI to the FEM system together with the TMSI;
(a4) allowing the FEM system to confirm whether there exists the TMSI received in step (a3), perform the user authentication based on the IMSI, confirm the user's bank account information if the authentication is approved, and provide the bank account information and the traffic fare to a banking system, thus requesting an accurate calculation;
(a5) allowing the banking system to perform the accurate calculation and provide the accurate calculation result to the FEM system; and
(a6) allowing the FEM system to transfer the accurate calculation result to the bus system.

39. A mobile traffic fare settlement method using a unique mobile identification code, comprising the steps of:
(a1) allowing a PMICA traffic terminal to extract a unique mobile identification code from a radio frequency signal emitted from a user's mobile communication terminal;
(a2) allowing the PMICA traffic terminal to transmit the unique mobile identification code and a settlement amount to a FEM system, thus requesting a traffic fare settlement;
(a3) allowing the FEM system to perform the user authentication based on the unique mobile identification code, and if the authentication is approved, provide the user identification information and the settlement amount to a banking system, thus requesting the traffic fare settlement;
(a4) allowing the banking system to determine whether to approve the traffic fare settlement based on the user identification information and transfer the approval result to a FEM system; and
(a5) allowing the FEM system to notify the PMICA traffic terminal of the approval result.

40. A mobile traffic fare settlement method using a unique mobile identification code, comprising the steps of:
(a1) allowing a PMICA traffic terminal to extract TMSI from a radio frequency signal emitted from a user's mobile communication terminal;
(a2) allowing the PMICA traffic terminal to transmit the TMSI and a settlement amount to a FEM system, thus requesting a traffic fare settlement;
(a3) allowing a mobile communication company system to extract TMSI from the radio frequency signal emitted from the user's mobile communication terminal, extract IMSI corresponding to the TMSI, and transfer the IMSI to the FEM system together with the TMSI;
(a4) allowing the FEM system to perform the user authentication based on the IMSI after confirming whether there exists the TMSI received in step (a3), and if authentication is approved, provide user identification information and the settlement amount to a banking system;
(a5) allowing the banking system to determine whether to approve the traffic fare settlement based on the user identification information, and transfer the approval result to the FEM system; and
(a6) allowing the FEM system to notify the PMICA traffic terminal of the approval result.

41. A mobile admission control method using a unique mobile identification code, comprising the steps of:
(a1) allowing a PMICA door lock to extract a unique mobile identification code from a radio frequency signal emitted from a user's mobile communication terminal;
(a2) allowing the PMICA door lock to transmit the unique mobile identification code to a FEM system, thus requesting authentication;
(a3) allowing the FEM system to perform the user authentication based on the unique mobile identification code and then transfer user identification information corresponding to the unique mobile identification code to the PMICA door lock; and
(a4) allowing the PMICA door lock to check the user identification information received in step (a3), thus determining whether to release the locking of the door.

42. A mobile admission control method using a unique mobile identification code, comprising the steps of:
(a1) allowing a PMICA door lock to extract TMSI from a radio frequency signal emitted from a user's mobile communication terminal;
(a2) allowing the PMICA door lock to transmit the TMSI to a FEM system, thus requesting authentication;
(a3) allowing a mobile communication company system to extract TMSI from the radio frequency signal emitted from the user's mobile communication terminal, extract IMSI corresponding to the TMSI, and transfer the IMSI to a FEM system together with the TMSI;
(a4) allowing the FEM system to perform the user authentication based on the IMSI after confirming whether there exists the TMSI received in step (a3), and transfer user identification information corresponding to the TMSI to the PMICA door lock; and
(a5) allowing the PMICA door lock to check the user identification information received in step (a4), thus determining whether to release the locking of the door.

43. A mobile check-up method using a unique mobile identification code, comprising the steps of:
(a1) allowing a PMICA police terminal to extract a unique mobile identification code from a radio frequency signal emitted from a user's mobile communication terminal;
(a2) allowing the PMICA police terminal to transmit the unique mobile identification code to a FEM system, thus requesting authentication;
(a3) allowing the FEM system to perform the user authentication based on the unique mobile identification code, and if the authentication is approved, provide corresponding user identification information to a police agency system; and
(a4) allowing the police agency system to confirm the identity of the user based on the user identification information and then transfer a corresponding identity confirmation data to the PMICA police terminal.

44. A mobile check-up method using a unique mobile identification code, comprising the steps of:
(a1) allowing a PMICA police terminal to extract TMSI from a radio frequency signal emitted from a user's mobile communication terminal;
(a2) allowing the PMICA police terminal to transmit the TMSI to a FEM system, thus requesting authentication;
(a3) allowing a mobile communication company system to extract TMSI from the radio frequency signal emitted from the user's mobile communication terminal, extract IMSI corresponding to the TMSI, and transfer the IMSI to the FEM system together with the TMSI;
(a4) allowing the FEM system to perform the user authentication based on the IMSI after confirming whether there exists the TMSI received in step (a3), and if the authentication is approved, transfer corresponding user identification information to a police agency system; and
(a5) allowing the police agency system to confirm the identity of the user based on the user identification information and then transfer a corresponding identity confirmation data to the PMICA police terminal.

45. The call information identification apparatus as claimed in claim 2, wherein the financial processing part comprises:
an identification code receiver for receiving the unique mobile identification code from the RF processing part;
a key input unit for receiving a variety of items accompanied with financial transaction;
a security module for encrypting the unique mobile identification code or financial transaction information;
a display module for displaying a variety of information occurring in a financial transaction processing procedure; and
a data processing unit for controlling the entire operation of the financial processing part.

46. The call information identification apparatus as claimed in claim 3, wherein the financial processing part comprises:
an identification code receiver for receiving the unique mobile identification code from the RF processing part;
a key input unit for receiving a variety of items accompanied with financial transaction;
a security module for encrypting the unique mobile identification code or financial transaction information;
a display module for displaying a variety of information occurring in a financial transaction processing procedure; and
a data processing unit for controlling the entire operation of the financial processing part.

47. The call information identification apparatus as claimed in claim 4, wherein the financial processing part comprises:
an identification code receiver for receiving the unique mobile identification code from the RF processing part;
a key input unit for receiving a variety of items accompanied with financial transaction;
a security module for encrypting the unique mobile identification code or financial transaction information;
a display module for displaying a variety of information occurring in a financial transaction processing procedure; and
a data processing unit for controlling the entire operation of the financial processing part.

48. The call information identification apparatus as claimed in claim 2, wherein the antenna of the RF processing part is disposed within a sealed space where the antenna of the mobile communication terminal is contained.

49. The call information identification apparatus as claimed in claim 3, wherein the antenna of the RF processing part is disposed within a sealed space where the antenna of the mobile communication terminal is contained.

50. The call information identification apparatus as claimed in claim 4, wherein the antenna of the RF processing part is disposed within a sealed space where the antenna of the mobile communication terminal is contained.

51. The user authentication system as claimed in claim 8, wherein the authentication processing terminal is a POS terminal.

52. The user authentication system as claimed in claim 9, wherein the authentication processing terminal is a POS terminal.

53. The user authentication system as claimed in claim 10, wherein the authentication processing terminal is a POS terminal.

54. The user authentication system as claimed in claim 8, wherein the authentication processing terminal is a CD/ATM.

55. The user authentication system as claimed in claim 9, wherein the authentication processing terminal is a CD/ATM.

56. The user authentication system as claimed in claim 10, wherein the authentication processing terminal is a CD/ATM.

57. The user authentication system as claimed in claim 8, wherein the authentication processing terminal is an automatic vending machine.

58. The user authentication system as claimed in claim 9, wherein the authentication processing terminal is an automatic vending machine.

59. The user authentication system as claimed in claim 10, wherein the authentication processing terminal is an automatic vending machine.

60. The user authentication system as claimed in claim 8, wherein the authentication processing terminal is a traffic terminal.

61. The user authentication system as claimed in claim 9, wherein the authentication processing terminal is a traffic terminal.

62. The user authentication system as claimed in claim 10, wherein the authentication processing terminal is a traffic terminal.

63. The user authentication system as claimed in claim 8, wherein the authentication processing terminal is a door lock.

64. The user authentication system as claimed in claim 9, wherein the authentication processing terminal is a door lock.

65. The user authentication system as claimed in claim 10, wherein the authentication processing terminal is a door lock.

66. The user authentication system as claimed in claim 8, wherein the authentication processing terminal is a wireless terminal for a check-up.

67. The user authentication system as claimed in claim 9, wherein the authentication processing terminal is a wireless terminal for a check-up.

68. The user authentication system as claimed in claim 10, wherein the authentication processing terminal is a wireless terminal for a check-up.

69. The user authentication system as claimed in claim 18, wherein the authentication processing terminal is a POS terminal.

70. The user authentication system as claimed in claim 19, wherein the authentication processing terminal is a POS terminal.

71. The user authentication system as claimed in claim 20, wherein the authentication processing terminal is a POS terminal.

72. The user authentication system as claimed in claim 18, wherein the authentication processing terminal is a CD/ATM.

73. The user authentication system as claimed in claim 19, wherein the authentication processing terminal is a CD/ATM.

74. The user authentication system as claimed in claim 20, wherein the authentication processing terminal is a CD/ATM.

75. The user authentication system as claimed in claim 18, wherein the authentication processing terminal is an automatic vending machine.

76. The user authentication system as claimed in claim 19, wherein the authentication processing terminal is an automatic vending machine.

77. The user authentication system as claimed in claim 20, wherein the authentication processing terminal is an automatic vending machine.

78. The user authentication system as claimed in claim 18, wherein the authentication processing terminal is a traffic terminal.

79. The user authentication system as claimed in claim 19, wherein the authentication processing terminal is a traffic terminal.

80. The user authentication system as claimed in claim 20, wherein the authentication processing terminal is a traffic terminal.

81. The user authentication system as claimed in claim 18, wherein the authentication processing terminal is a door lock.

82. The user authentication system as claimed in claim 19, wherein the authentication processing terminal is a door lock.

83. The user authentication system as claimed in claim 20, wherein the authentication processing terminal is a door lock.

84. The user authentication system as claimed in claim 18, wherein the authentication processing terminal is a wireless terminal for a check-up.

85. The user authentication system as claimed in claim 19, wherein the authentication processing terminal is a wireless terminal for a check-up.

86. The user authentication system as claimed in claim 20, wherein the authentication processing terminal is a wireless terminal for a check-up.
